(19) United States
(12) Patent Application Publication
(10) Pub. No.: US 2020/0368734 A1
(43) Pub. Date: Nov. 26, 2020

(54) A COMPOSITION COMPRISING A MIXED METAL OXIDE AND A MOLDING COMPRISING A ZEOLITIC MATERIAL HAVING FRAMEWORK TYPE CHA AND AN ALKALINE EARTH METAL

(71) Applicant: BASF SE, Ludwigshafen am Rhein (DE)

(72) Inventors: Robert MCGUIRE, Florham Park, NJ (US); Achim WECHSUNG, Ludwigshafen am Rhein (DE); Christiane KURETSCHKA, Ludwigshafen am Rhein (DE); Ivana JEVTOVIKJ, Heidelberg (DE); Andreas KUSCHEL, Heidelberg (DE); Stephan A. SCHUNK, Heidelberg (DE)

(21) Appl. No.: 16/635,236

(22) PCT Filed: Aug. 8, 2018
(86) PCT No.: PCT/EP2018/071495

§ 371 Date: Jan. 30, 2020

(30) Foreign Application Priority Data
Aug. 8, 2017 (EP) 17185280.9

(51) Int. Cl. B01J 29/78; B01J 29/70; B01J 29/85; B01J 37/00; B01J 37/04; B01J 37/03; C10G 2/00

(52) U.S. Cl. CPC B01J 29/783; B01J 29/7015; B01J 29/85; B01J 37/0018; B01J 37/04; C10G 2400/20; C10G 2/334; C10G 2/332; B01J 2229/186; B01J 2229/20; B01J 37/03

(57) ABSTRACT

The present invention relates to a composition comprising a) a molding comprising a zeolitic material having framework type CHA, wherein the zeolitic material comprises one or more alkaline earth metals M and b) a mixed metal oxide comprising chromium, zinc, and aluminium. It also relates to the use of the composition in a process for producing C2 to C4 olefins from syngas.

The present invention relates to a composition comprising a) a molding comprising a zeolitic material having framework type CHA, wherein the zeolitic material comprises one or more alkaline earth metals M and b) a mixed metal oxide comprising chromium, zinc, and aluminium. The invention is further directed to a process for preparing the composition. The invention further relates to the use of the composition in a process for producing C2 to C4 olefins from syngas.

In view of increasing scarcity of mineral oil deposits which serve as a starting material for the preparation of lower hydrocarbons and derivatives thereof, alternative processes for preparing such commodity chemicals are becoming increasingly important. In alternative processes for obtaining lower hydrocarbons and derivatives thereof, specific catalysts are frequently used to obtain lower hydrocarbons and derivatives thereof, such as unsaturated lower hydrocarbons in particular, with maximum selectivity from other raw materials and/or chemicals. In this context, important processes include those in which methanol as a starting chemical is subjected to a catalytic conversion which can generally lead to a mixture of hydrocarbons and derivatives thereof, and also aromatics.

In the case of such catalytic conversions, the particular challenge is to refine the catalysts used therein, and also the process regime and parameters thereof, in such a way that a few very specific products are formed with maximum selectivity in the catalytic conversion. In the past few decades, particular significance has been gained by those processes which enable the conversion of methanol to olefins and are accordingly characterized as methanol-to-olefin processes (MTO). For this purpose, there has been development particularly of catalysts and processes which convert the conversion of methanol via the dimethyl ether intermediate to mixtures the main constituents of which are ethene and propene.

U.S. Pat. No. 4,049,573, for example, relates to a catalytic process for the conversion of lower alcohols and ethers thereof, and especially methanol and dimethyl ether, to obtain a hydrocarbon mixture with a high proportion of C2-C3-olefins and monocyclic aromatics and especially paraxylene.

Goryainova et al., describes the catalytic conversion of dimethyl ether to lower olefins using magnesium-containing zeolites.

Typically, syngas conversion to olefins occurs in separates steps. First the syngas is converted to methanol and in a second stage methanol is converted to olefins. Syngas conversion to methanol is equilibrium limited with typical one-pass COₓ conversion of 63%. Methanol is separated from unprocessed syngas and then converted to olefins. The so called Lurgi's methanol-to-propylene (MTP) process uses separate fixed-bed reactors to produce the intermediate compound dimethyl ether (DME) and olefins, whereas other processes rely on a fluidized-bed reactor for the methanol-to-olefin conversion. The reactor effluent of these processes contains a mixture of hydrocarbons (olefins, alkanes), which requires several purification steps. Wan, V. Y. discloses that often, depending on the intended product spectrum, undesired compounds are recycled back to the olefin reactor (Lurgi process) or cracked in a separate stage to enhance yield (Total/UOP process).

In Li, J., X. Pan and X. Bao, further alternative technology to produce olefins from synthesis gas (syngas) has been proposed which combines the synthesis steps in a single reactor wherein the syngas is first converted to methanol which is then dehydrated to olefins via the intermediate dimethyl ether (DME).

Propylene consumption is growing and predicted to grow in the next years by more than 4% annually. There is hence the need of a process that produces propylene in a high amount, a high selectivity, and that is economically efficient.

In spite of the advances which have been achieved with respect to the selection of raw materials and the conversion products thereof which can be used for the production of olefins, there is still a need for novel processes and catalysts which give a higher efficiency for the conversion and selectivity. More particularly, there is a constant need for novel processes and catalysts which, proceeding from the raw materials, lead via a minimum number of intermediates very selectively to the desired end product. Furthermore, it is desirable for efficiency purposes to be enhanced further by development of processes which require a minimum number of workup steps for the intermediates in order that they can be used in the subsequent stage

Surprisingly, it was found that C2 to C4 olefins and particularly propylene is produced in high amount, high selectivity and in an economically efficient one step process by using a catalyst composition comprising a molding comprising a CHA zeolitic material comprising an alkaline earth metal and a mixed metal oxide comprising chromium, zinc, and aluminium.

Therefore the present invention relates to a composition comprising
a) a molding comprising a zeolitic material having framework type CHA, wherein the zeolitic material has a framework structure comprising a tetravalent element Y, a trivalent element X, and oxygen, wherein the zeolitic material further comprises one or more alkaline earth metals M; and
b) a mixed metal oxide comprising chromium, zinc, and aluminum;

wherein Y is one or more of Si, Ge, Sn, Ti, and Zr;

wherein X is one or more of Al, B, Ga, and In.

Generally, there is no specific restriction with respect to the zeolitic material provided that it has a framework type CHA comprising a tetravalent element Y, a trivalent element X, oxygen, H and further comprises one or more alkaline earth metals M. As to the tetravalent element Y, it is preferably one or more of Si, Ge, Sn, Ti, and Zr. More preferably, Y comprises, more preferably is Si. As to the trivalent element X, it is preferably one or more of Al, B, Ga, and In. More preferably X comprises, more preferably is Al. More preferably, the Y is Si and X is Al.

Generally, the tetravalent element Y and the trivalent element X are present in a certain molar ratio Y:X calculated as YO₂:X₂O₃. Preferably, the molar ratio Y:X is at least 5:1, more preferably Y:X in the range of from 5:1 to 50:1, more preferably in the range of from 10:1 to 45:1, more preferably in the range of from 15:1 to 40:1.1.

Generally, there is no specific restriction with respect to the composition of the zeolitic material, provided that it comprises the tetravalent element Y, the trivalent element X, O and H as disclosed herein above. Preferably at least 95 weight-%, more preferably at least 98 weight-%, more preferably at least 99 weight-%, more preferably at least 99.5 weight-%, more preferably at least 99.9 weight % of the framework structure of the zeolitic material consist of Y, X, O and H. Preferably at most 1 weight-%, more preferably at most 0.1 weight-%, more preferably at most 0.01 weight-%, more preferably from 0 to 0.001 weight-% of the framework structure of the zeolitic material consist of phosphorous.

Preferably the one or more alkaline earth metals M is one or more of Be, Mg, Ca, Sr and Ba. More preferably the one or more alkaline earth metals M comprises, more preferably is Mg. It is further contemplated that the one or more alkaline earth metals M is present in the zeolitic material at least partly in an oxidic form. Preferably, the zeolitic material comprises the one or more alkaline earth metals M, calculated as elemental alkaline earth metal, in a total amount in the range of from 0.1 to 5 weight-%, more preferably in the range of from 0.4 to 3 weight-%, more preferably in the range of from 0.75 to 2 weight-%, based on the weight of the zeolitic material comprised in the molding. The term “total amount” as used herein in this context relates to the sum of the amount of all alkaline earth metals M present in the zeolitic material.

In addition to the tetravalent element Y, the trivalent element X, oxygen, H and the alkaline earth metal M, the zeolitic material may further comprise an alkali metal. No specific restriction exists as to the chemical nature of alkali metal. Preferably, the alkali metal comprises one or more of Li, Na, K, and Cs, more preferably one or more of Na, K, and Cs. More preferably, the alkali metal comprises, more preferably is sodium.

With regard to the composition of the zeolitic material, it is preferred that at least 95 weight-%, more preferably at least 98 weight-%, more preferably at least 99 weight-%, more preferably at least 99.5 weight-%, more preferably at least 99.9 weight-% of the zeolitic material consist of Y, X, O, H, the one or more alkaline earth metals M and optionally an alkali metal.

The zeolitic material of the composition according to the present invention preferably exhibits a specific amount of medium acid sites. The term “amount of medium acid sites” as used in the context of the present invention is defined as the amount of desorbed ammonia per mass of the calcined zeolitic material as measured according to the temperature programmed desorption of ammonia in the temperature range of from 100 to 350° C. determined according to the method as described in Reference Example 1.2. Preferably, the amount of medium acid sites in the zeolitic material is at least 0.7 mmol/g, more preferably in the range of from 0.7 to 2 mmol/g, more preferably in the range of 0.7 to 1.1 mmol/g.

It is further contemplated that the zeolitic material has an amount of strong acid sites. The term “amount of strong acid sites” as used in the context of the present invention is defined as the amount of desorbed ammonia per mass of the calcined zeolitic material as measured according to the temperature programmed desorption of ammonia in the temperature range of from 351 to 500° C. determined according to the method as described in Reference Example 1.2. Preferably, the amount of strong acid sites is less than 1.0 mmol/g, preferably less than of 0.9 mmol/g, more preferably less than 0.7 mmol/g.

The zeolitic material according to the present invention and as disclosed herein above is comprised in a molding. In addition to the zeolitic material, the molding preferably further comprises a binder material. Preferably, the binder material comprises, more preferably is one or more of graphite, silica, titania, zirconia, alumina, and a mixed oxide of two or more of silicon, titanium, zirconium, and aluminium. More preferably, the binder material comprises silica, more preferably is silica.

As to the geometry of the molding, there are no specific restrictions, and it may realize according to the specific needs of the use of the molding. Preferably, the molding has a rectangular, a triangular, a hexagonal, a square, an oval or a circular cross section, and/or is in the form of a star, a tablet, a sphere, a cylinder, a strand, or a hollow cylinder.

In the molding of the present invention, the weight ratio of the zeolitic material relative to the binder material is preferably in the range of from 1:1 to 20:1, more preferably in the range of from 2:1 to 10:1, more preferably in the range of from 3:1 to 5:1.

The molding of the present invention preferably comprises pores, more preferably the micropores comprised in the zeolitic materials, and more preferably, mesopores in addition to micropores. The micropores have a diameter of less than 2 nanometer determined according to DIN 66135 and the mesopores have a diameter in the range of from 2 to 50 nanometer determined according to DIN 66133. Further, the molding of the present invention may comprise macropores, i.e. pores having a diameter of more than 50 nanometers.

Preferably, the molding comprised in the composition is a calcined molding, wherein the term “a calcined molding” preferably relates to a molding which has been subjected at a gas atmosphere having a temperature in the range of from 400 to 600° C.

According to the present invention, it is preferred that the molding according to (a) as disclosed herein above is obtainable or obtained or preparable or prepared by a process comprising
(i.1) providing a zeolitic material having framework type CHA, wherein the zeolitic material has a framework structure comprising a tetravalent element Y, a trivalent element X, and oxygen, wherein Y is one or more of Si, Ge, Sn, Ti, and Zr, wherein X is one or more of Al, B, Ga, and In;
(i.2) impregnating the zeolitic material obtained from (i.1) with a source of the one or more alkaline earth metals;
(i.3) preparing a molding comprising the impregnated zeolitic material obtained from (i.2) and optionally a binder material.

The process for preparing the molding of a) comprising steps (i.1), (i.2) and (1.3) is disclosed in details in the below paragraphs related to the process for preparing the composition.

Preferably at least 95 weight-%, more preferably at least 98 weight-%, more preferably at least 99 weight-%, more preferably at least 99.5 weight-%, more preferably at least 99.9 weight % of the molding consist of the zeolitic material and optionally the binder material, wherein the zeolitic material and the binder material are as disclosed herein above.

As disclosed above the composition comprises in addition to the molding as disclosed herein above a mixed metal oxide comprising chromium, zinc, and aluminium.

Preferably, the mixed metal oxide has a BET specific surface area in the range of from 5 to 150 m²/g, more preferably in the range of from 15 to 120 m²/g, determined as described in Reference Example 1.1 herein.

Preferably at least 98 weight-%, more preferably at least 99 weight-%, more preferably at least 99.5 weight-% of the mixed metal oxide consists of chromium, zinc, aluminum, and oxygen. Preferably, the weight ratio of the zinc, calculated as element, relative to the chromium, calculated as element, is in the range of from 2.5:1 to 6.0:1, more preferably in the range of from 3.0:1 to 5.5:1, more preferably in the range of from 3.5:1 to 5.0:1. Preferably, the weight ratio of the aluminum, calculated as element, relative to the chromium, calculated as element, is in the range of from 0.1:1 to 2:1, more preferably in the range of from 0.15:1 to 1.5:1, more preferably in the range of from 0.25:1 to 1:1.

Preferably, the weight ratio of the mixed metal oxide relative to the zeolitic material is at least 0.2:1, more preferably in the range of from 0.2:1 to 5:1, more preferably in the range of from 0.5 to 3:1, more preferably in the range of from 0.9:1 to 1.5:1.

Preferably at least 95 weight-%, more preferably at least 98 weight-%, more preferably at least 99 weight-%, more preferably at least 99.5 weight-%, more preferably at least 99.9 weight % of the composition consist of the molding and the mixed metal oxide.

Preferably the composition as herein disclosed is a mixture of the molding and the mixed metal oxide as disclosed herein above

The composition of the present invention can be used for any suitable purpose. Preferably, it is used as a catalyst or as a catalyst component, preferably for preparing C2 to C4 olefins, more preferably for preparing C2 to C4 olefins from a synthesis gas comprising hydrogen and carbon monoxide, more preferably for preparing C2 to C4 olefins from a synthesis gas comprising hydrogen and carbon monoxide wherein the reaction is carried out as a one step process. More preferably, the composition is used as a catalyst or as a catalyst component for preparing propene, more preferably for preparing propene from a synthesis gas comprising hydrogen and carbon monoxide, more preferably for preparing propylene from a synthesis gas comprising hydrogen and carbon monoxide wherein the reaction is carried out in one step process.

The present invention further relates to a process for preparing the composition as disclosed herein above. Preferably, the process comprises
(i) providing a molding comprising a zeolitic material having framework type CHA, wherein the zeolitic material has a framework structure comprising a tetravalent element Y, a trivalent element X, and oxygen, wherein the zeolitic material further comprises one or more alkaline earth metals M, wherein Y is one or more of Si, Ge, Sn, Ti, and Zr, wherein X is one or more of Al, B, Ga, and In;
(ii) providing a mixed metal oxide comprising chromium, zinc, and aluminum;
(iii) mixing the molding provided according to (i) with the mixed metal oxide provided according to (ii), obtaining the composition.

Preferably, providing a molding according to (i) comprises
(i.1) providing a zeolitic material having framework type CHA, wherein the zeolitic material has a framework structure comprising a tetravalent element Y, a trivalent element X, and oxygen, wherein Y is one or more of Si, Ge, Sn, Ti, and Zr, wherein X is one or more of Al, B, Ga, and In;
(i.2) impregnating the zeolitic material obtained from (i.1) with a source of the one or more alkaline earth metals;
(i.3) preparing a molding comprising the impregnated zeolitic material obtained from (i.2) and optionally a binder material.

Preferably, as described above, the zeolitic material having framework type CHA provided in (i.1) has a framework structure comprising a tetravalent element Y and a trivalent element X, wherein Y is Si and X is Al. In the zeolitic material the molar ratio Y:X, calculated as YO₂:X₂O₃ is preferably at least 5:1, more preferably in the range of from 5:1 to 50:1, more preferably in the range of from 10:1 to 45:1, more preferably in the range of from 15:1 to 40:1.

Preferably, as described above, at least 95 weight-%, more preferably at least 98 weight-%, more preferably at least 99 weight-%, more preferably at least 99.5 weight-%, more preferably at least 99.9 weight % of the framework structure of the zeolitic material provided according to (i.1) consist of Y, X, O and H.

Preferably, as described above, at most 1 weight-%, more preferably at most 0.1 weight-%, more preferably at most 0.01 weight-%, more preferably from to 0.001 weight-% of the framework structure of the zeolitic material provided according to (i.1) consist of phosphorous.

In addition to the tetravalent element Y, the trivalent element X, and oxygen, and H, the zeolitic material of (i.1) may comprise an alkali metal as described above. Preferably at least 95 weight %, more preferably at least 98 weight-%, more preferably at least 99 weight-%, more preferably at least 99.5 weight-%, more preferably at least 99.9 weight-% of the zeolitic material provided according to (i.1) consist of Y, X, O, H, and optionally an alkali metal. Preferably, the alkali metal comprises, preferably is sodium.

It is further contemplated, as described above, that the zeolitic material provided according to (i.1) has an amount of medium acid sites. The amount of medium acid sites is the amount of desorbed ammonia per mass of the calcined zeolitic material as measured according to the temperature programmed desorption of ammonia in the temperature range of from 100 to 350° C. determined according to the method as described in Reference Example 1.2. Preferably, the amount of medium acid sites in the zeolitic material provided according to (i.1) is at least 0.7 mmol/g, more preferably in the range of from 0.7 to 2 mmol/g, more preferably in the range of 0.7 to 1.1 mmol/g.

As described above, it is further contemplated that the zeolitic material provided according to (i.1) has an amount of strong acid sites. The amount of strong acid sites is the amount of desorbed ammonia per mass of the calcined zeolitic material provided according to (i.1) as measured according to the temperature programmed desorption of ammonia in the temperature range of from 351 to 500° C. determined according to the method as described in Reference Example 1.2. Preferably, the amount of strong acid sites is less than 1.0 mmol/g, preferably less than of 0.9 mmol/g, more preferably less than 0.7 mmol/g.

As described above, the zeolitic material comprises one or more alkaline earth metals. The one or more alkaline earth metals is provided in the zeolitic material preferably by impregnating the zeolitic material with a suitable source of the one or more alkaline earth metals according to (i.2).

Preferably, the source of the one or more alkaline earth metals according to (i.2) is a salt of the one or more alkaline earth metals, such as an inorganic salt like a halide, a sulfate, a nitrate or the like. For the purpose of preparing the zeolitic material of the composition as disclosed herein, it is preferred that the source of the one or more alkaline earth metals according to (i.2) is a salt of the one or more alkaline earth metals dissolved in one or more solvents, more preferably dissolved in water.

As to the impregnation of the zeolitic material of (i.1) with the source of the one or more alkaline earth metals, there is no particular restriction, provided that the zeolitic material of the composition as herein disclosed is obtained. Preferably, impregnating the zeolitic material according to (i.2) comprises one or more of wet-impregnating the zeolitic material and spray-impregnating the zeolitic material, wherein spray-impregnating the zeolitic material may be preferred.

Step (i.2) preferably further comprises calcining the zeolitic material obtained from impregnation. The calcination may optionally be carried out after drying the zeolitic material obtained from impregnation. The calcining is preferably carried out in a gas atmosphere having a temperature in the range of from 400 to 650° C., more preferably in the range of from 450 to 600° C. As to the gas atmosphere, there is no specific restriction, provided that a calcined zeolitic material is obtained. Preferably, the gas atmosphere is nitrogen, oxygen, air, lean air, or a mixture of two or more thereof. If a drying is carried out prior to calcining, it is preferably carried out in a gas atmosphere having a temperature in the range of from 75 to 200° C., preferably in the range of from 90 to 150° C. The gas atmosphere of the drying is preferably nitrogen, oxygen, air, lean air, or a mixture of two or more thereof.

The impregnated zeolitic material obtained from (i.2) comprises of Y, X, O, H, the one or more alkaline earth metals M, and optionally an alkali metal. Preferably, as disclosed above, at least 95 weight-%, more preferably at least 98 weight-%, more preferably at least 99 weight-%, more preferably at least 99.5 weight-%, more preferably at least 99.9 weight-% of the impregnated zeolitic material obtained from (i.2) consist of Y, X, O, H, the one or more alkaline earth metals M, and optionally an alkali metal.

Preferably, the impregnated zeolitic material obtained from (i.2) comprises the one or more alkaline earth metals M, calculated as elemental alkaline earth metal, in a total amount in the range of from 0.1 to 5 weight-%, more preferably in the range of from 0.4 to 3 weight-%, more preferably in the range of from 0.75 to 2 weight-%, based on the weight of the zeolitic material.

Generally there is no specific restriction as to how the molding is prepared according to (i.3). Preparing a molding according to (i.3) preferably comprises
(i.3.1) preparing a mixture of the impregnated zeolitic material obtained from (i.2) and a source of a binder material;
(i.3.2) subjecting the mixture prepared according to (i.3.1) to shaping.

Preferably, the source of the binder material of (i.3.1) is one or more of a source of graphite, a source of silica, a source of titania, a source of zirconia, a source of alumina and a source of a mixed oxide of two or more of silicon, titanium, zirconium and aluminium. The source of a binder material more preferably comprises, more preferably is a source of silica. It is further preferred that the source of silica comprises one or more of a colloidal silica, a fumed silica, and a tetraalkoxysilane. More preferably, the source of the binder material comprises, more preferably is a colloidal silica.

The mixture prepared according to (i.3.1) may further comprise a pasting agent. The pasting agent preferably comprises one or more of an organic polymer, an alcohol and water. The organic polymer is preferably one or more of a carbohydrate, a polyacrylate, a polymethacrylate, a polyvinyl alcohol, a polyvinylpyrrolidone, a polyisobutene, a polytetrahydrofuran, and a polyethlyene oxide. The carbohydrate is preferably one or more of cellulose and cellulose derivative, wherein the cellulose derivative is preferably a cellulose ether, more preferably a hydroxyethyl methylcellulose. The pasting agent more preferably comprises one or more of water and a carbohydrate.

Preferably, the mixture obtained in (i.3.1) is further subjected to shaping according to (i.3.2). There is no specific restriction as to the method of shaping the molding of (i.3.1). Preferably, the shaping of (i.3.2) comprises subjecting the mixture prepared according to (i.3.1) to spray-drying, to spray-granulation, or to extrusion, more preferably to extrusion.

Preferably, the process of the present invention further comprises
(i.3.3) calcining the molding obtained from (i.3.2).

The calcining is carried out after optionally drying the molding obtained from (i.3.2). The calcining is preferably carried out in a gas atmosphere having a temperature in the range of from 400 to 650° C., more preferably in the range of from 450 to 600° C. The gas atmosphere of the calcining is preferably nitrogen, oxygen, air, lean air, or a mixture of two or more thereof. If drying is carried out prior to calcining, the drying is preferably carried out in a gas atmosphere having a temperature in the range of from 75 to 200° C., more preferably in the range of from 90 to 150° C., The gas atmosphere of the drying is preferably nitrogen, oxygen, air, lean air, or a mixture of two or more thereof.

Hence, (i.3) preferably comprises
(i.3.1) preparing a mixture of the impregnated zeolitic material obtained from (i.2) and a source of a binder material;
(i.3.2) subjecting the mixture prepared according to (i.3.1) to shaping
(i.3.3) calcining the molding obtained from (i.3.2), after drying, wherein the calcining is preferably carried out in a gas atmosphere having a temperature in the range of from 450 to 600° C., wherein the gas atmosphere is preferably nitrogen, oxygen, air, lean air, or a mixture of two or more thereof, wherein the drying is preferably carried out in a gas atmosphere having a temperature in the range of from 90 to 150° C., wherein the gas atmosphere is preferably nitrogen, oxygen, air, lean air, or a mixture of two or more thereof.

Step (ii) as disclosed above comprises providing a mixed metal oxide comprising chromium, zinc, and aluminium. There is no specific restriction as to the provision of the mixed metal oxide comprising chromium, zinc, and aluminium. Preferably, providing the mixed metal oxide according to (ii) comprises
(ii.1) co-precipitating a precursor of the mixed metal oxide from sources of the chromium, the zinc, and the aluminum;
(ii.2) washing the precursor obtained from (ii.1);
(ii.3) drying the washed precursor obtained from (ii.2);
(ii.4) calcining the washed precursor obtained from (ii.3).

There is no specific restriction as to method for co-precipitating the precursor of the mixed metal oxide from sources of the chromium, the zinc, and the aluminum according to (ii.1). Preferably, co-precipitating a precursor of the mixed metal oxide from sources of the chromium, the zinc, and the aluminum according to (ii.1) comprises
(ii.1.1) preparing a mixture comprising water and the sources of the chromium, the zinc, and the aluminum;
(ii.1.2) adding a precipitation agent to the mixture prepared according to (ii.1.1);
(ii.1.3) subjecting the mixture obtained from (ii.1.2) to heating to a temperature of the mixture in the range of from 50 to 90° C. and keeping the mixture at this temperature for a period of time;
(ii.1.4) optionally drying the mixture obtained from (ii.1.3);
(ii.1.5) calcining the mixture obtained from (ii.1.3) or from (ii.1.4), obtaining the mixed metal oxide.

With regard to the sources of the chromium, the zinc, and the aluminum of (ii.1.1) there is no particular restriction provided that the mixed metal oxide of the composition as disclosed herein is obtained. Preferably the sources of the chromium, the zinc, and the aluminum of (ii.1.1) comprise one or more of a chromium salt, a zinc salt, and an aluminum salt. Preferably, the chromium salt is a chromium nitrate, more preferably a chromium(III) nitrate. Preferably, the zinc salt is a zinc nitrate, more preferably a zinc(II) nitrate. Preferably, the aluminum salt is an aluminum nitrate, more preferably an aluminum(III) nitrate.

Preferably, in the mixture prepared in (ii.1.1), the weight ratio of the zinc, calculated as element, relative to the chromium, calculated as element, is in the range of from 2.5:1 to 6:1, more preferably in the range of from 3.0:1 to 5.5:1, more preferably in the range of from 3.5:1 to 5:1.

Preferably, in the mixture prepared in (ii.1.1), the weight ratio of the aluminum, calculated as element, relative to the chromium, calculated as element, is in the range of from 0.1:1 to 2:1, more preferably in the range of from 0.15:1 to 1.5:1, more preferably in the range of from 0.25:1 to 1:1.

More preferably in the mixture prepared in (ii.1.1), the weight ratio of the zinc, calculated as element, relative to the chromium, calculated as element, is in the range of from 3.5:1 to 5:1 and the weight ratio of the aluminum, calculated as element, relative to the chromium, calculated as element, is in the range of from 0.25:1 to 1:1.

The precipitation agent according to (ii.1.2) preferably comprises an ammonium carbonate, more preferably an ammonium carbonate dissolved in water.

With regard to subjecting the mixture obtained from (ii.1.3) to heating, it is preferred to heat the mixture to a temperature in the range of from 50 to 90° C., preferably in the range of from 60 to 80° C. Preferably, the mixture is further kept at this temperature for a period of time which is preferably in the range of from 0.1 to 12 h, more preferably in the range of from 0.5 to 6 h.

If drying according to (ii.1.4) is carried out, it preferred to carry it out in a gas atmosphere having a temperature in the range of from 75 to 200° C., more preferably in the range of from 90 to 150° C. The gas atmosphere of the drying of (ii.1.4) is preferably oxygen, air, lean air, or a mixture of two or more thereof.

With regard to the calcining the mixture obtained from (ii.1.3) or from (ii.1.4), preferably from (ii.1.4), there is no specific restriction provided that the mixed metal oxide of the composition as herein disclosed is obtained. The calcining is preferably carried out in a gas atmosphere having a temperature in the range of from 300 to 900° C., more preferably in the range of from 350 to 800° C. The gas atmosphere of the calcining is preferably oxygen, air, lean air, or a mixture of two or more thereof, obtaining the mixed metal oxide.

According to (ii.1.5), the mixture is more preferably calcined at a temperature in the range of from 350 to 440° C., preferably in the range of from 375 to 425° C. Alternatively, according to (ii.1.5), the mixture is more preferably calcined at a temperature in the range of from 450 to 550° C., preferably in the range of from 475 to 525° C. Alternatively according to (ii.1.5), the mixture is more preferably calcined at a temperature in the range of from 700 to 800° C., preferably in the range of from 725 to 775° C.

Further, the present invention is directed to a process for preparing a molding, the process comprising steps (i.1), (i.2) and (i.3) as disclosed above, preferably to a process for preparing a molding, the process comprising steps (i.1), (i.2) and (i.3) wherein (i.3) comprises steps (i.3.1) and (i.3.2) as disclosed above, more preferably to a process for preparing a molding, the process comprising steps (i.1), (i.2) and (i.3) wherein (i.3) comprises steps (i.3.1), (i.3.2) and (i.3.3) as disclosed above.

Further, the present invention is directed to a molding obtained or obtainable or preparable of prepared by the process comprising steps (i.1), (i.2) and (i.3) as disclosed above, preferably by a process comprising steps (i.1), (i.2) and (i.3) wherein (i.3) comprises steps (i.3.1) and (i.3.2) as disclosed above, more preferably by a process comprising steps (i.1), (i.2) and (i.3) wherein (i.3) comprises steps (i.3.1), (i.3.2) and (i.3.3) as disclosed above.

Further, the present invention is directed to a process for preparing a mixed metal oxide, the process comprising steps (ii.1), (ii.2), (ii.3) and (ii.4) as disclosed above, preferably to a process for preparing a mixed metal oxide, the process comprising steps (ii.1), (ii.2), (ii.3) and (ii.4), wherein step (ii.1) comprises steps (ii.1.1), (ii.1.2), (ii.1.3), (ii.1.4) and (ii.1.5), as disclosed above.

Further, the present invention is directed to a mixed metal oxide obtainable or obtained or preparable or prepared by a process comprising steps (ii.1), (ii.2), (ii.3) and (ii.4) as disclosed above, preferably by a process comprising steps (ii.1), (ii.2), (ii.3) and (ii.4), wherein step (ii.1) comprises steps (ii.1.1), (ii.1.2), (ii.1.3), (ii.1.4) and (ii.1.5) as disclosed above.

Further, the present invention is directed to a process for preparing a composition, the process comprising steps (i), (ii) and (iii) all the step as disclosed above. The present invention is preferably directed to a process for preparing a composition, the process comprising steps (i), (ii) and (iii), wherein step (i) comprises steps (i.1), (i.2) and (i.3), all steps as disclosed above. The present invention is more preferably directed to a process for preparing a composition, the process comprising steps (i), (ii) and (iii), wherein step (i) comprises steps (i.1), (i.2) and (i.3), and wherein step (i.3) comprises steps (i.3.1) and (i.3.2), all steps as disclosed above. The present invention is more preferably directed to a process for preparing a composition, the process comprising steps (i), (ii) and (iii), wherein step (i) comprises steps (i.1), (i.2) and (i.3), and wherein step (i.3) comprises steps (i.3.1) and (i.3.2) and (i.3.3) all steps as disclosed above. The present invention is preferably directed to a process for preparing a composition, the process comprising steps (i), (ii) and (iii), wherein step (ii) comprises steps (ii.1), (ii.2), (ii.3) and (ii.4), all steps as disclosed above. The present invention is more preferably directed to a process for preparing a composition, the process comprising steps (i), (ii) and (iii), wherein step (ii) comprises steps (ii.1), (ii.2), (ii.3) and (ii.4) and wherein step (ii.1) comprises steps (ii.1.1), (ii.1.2), (ii.1.3), (ii.1.4), and (ii.1.5), all steps as disclosed above. The present invention is preferably directed to a process for preparing a composition, the process comprising steps (i), (ii) and (iii), wherein step (i) comprises steps (i.1), (i.2) and (i.3) and wherein step (ii) comprises steps (ii.1), (ii.2), (ii.3) and (ii.4), all steps as disclosed above. The present invention is more preferably directed to a process for preparing a composition, the process comprising steps (i), (ii) and (iii), wherein step (i) comprises steps (i.1), (i.2) and (i.3), wherein step (ii) comprises steps (ii.1), (ii.2), (ii.3) and (ii.4) and wherein step (ii.1) comprises steps (ii.1.1), (ii.1.2), (ii.1.3), (ii.1.4), and (ii.1.5) all steps as disclosed above. The present invention is more preferably directed to a process for preparing a composition, the process comprising steps (i), (ii) and (iii), wherein step (i) comprises steps (i.1), (i.2) and (i.3), and wherein step (i.3) comprises steps (i.3.1) and (i.3.2) and wherein step (ii) comprises steps (ii.1), (ii.2), (ii.3) and (ii.4), all steps as disclosed above. The present invention is more preferably directed to a process for preparing a composition, the process comprising steps (i), (ii) and (iii), wherein step (i) comprises steps (i.1), (i.2) and (i.3), and wherein step (i.3) comprises steps (i.3.1) and (i.3.2), wherein step (ii) comprises steps (ii.1), (ii.2), (ii.3) and (ii.4) and wherein step (ii.1) comprises steps (ii.1.1), (ii.1.2), (ii.1.3), (ii.1.4) and (ii.1.5), all steps as disclosed above. The present invention is more preferably directed to a process for preparing a composition, the process comprising steps (i), (ii) and (iii), wherein step (i) comprises steps (i.1), (i.2) and (i.3), and wherein step (i.3) comprises steps (i.3.1), (i.3.2) and (1.3.3) and step (ii) comprises steps (ii.1), (ii.2), (ii.3) and (ii.4), all steps as disclosed above. Therefore the present invention is more preferably directed to a process for preparing a composition, the process comprising steps (i), (ii) and (iii), wherein step (i) comprises steps (i.1), (i.2) and (i.3), and wherein step (i.3) comprises steps (i.3.1) (i.3.2) and (1.3.3) and wherein step (ii) comprises steps (ii.1), (ii.2), (ii.3) and (ii.4) and wherein step (ii.1) comprises steps (ii.1.1), (ii.1.2), (ii.1.3), (ii.1.4), and (ii.1.5) all steps as disclosed above.

Therefore the present invention is directed to a composition obtained or obtainable by a process comprising steps (i), (ii) and (iii), all steps as disclosed above. The present invention is preferably directed to a composition obtained or obtainable by a process comprising steps (i), (ii) and (iii), wherein step (i) comprises steps (i.1), (i.2) and (i.3), all steps as disclosed above. The present invention is more preferably directed to a composition obtained or obtainable by a process comprising steps (i), (ii) and (iii), wherein step (i) comprises steps (i.1), (i.2) and (i.3), and wherein step (i.3) comprises steps (i.3.1) and (i.3.2), all steps as disclosed above. The present invention is more preferably directed to a composition obtained or obtainable by a process comprising steps (i), (ii) and (iii), wherein step (i) comprises steps (i.1), (i.2) and (i.3), and wherein step (i.3) comprises steps (i.3.1) and (i.3.2) and (i.3.3) all steps as disclosed above.

The present invention is preferably directed to a composition obtained or obtainable by a process comprising steps (i), (ii) and (iii), wherein step (ii) comprises steps (ii.1), (ii.2), (ii.3) and (ii.4), all steps as disclosed above. The present invention is more preferably directed to a composition obtained or obtainable by a process comprising steps (i), (ii) and (iii), wherein step (ii) comprises steps (ii.1), (ii.2), (ii.3) and (ii.4) and wherein step (ii.1) comprises steps (ii.1.1), (ii.1.2), (ii.1.3), (ii.1.4), and (ii.1.5), all steps as disclosed above. The present invention is preferably directed to a composition obtained or obtainable by a process comprising steps (i), (ii) and (iii) wherein step (i) comprises steps (i.1), (i.2) and (i.3) and wherein step (ii) comprises steps (ii.1), (ii.2), (ii.3) and (ii.4), all steps as disclosed above. The present invention is more preferably directed to a composition obtained or obtainable by a process comprising steps (i), (ii) and (iii), wherein step (i) comprises steps (i.1), (i.2) and (i.3), wherein step (ii) comprises steps (ii.1), (ii.2), (ii.3) and (ii.4) and wherein step (ii.1) comprises steps (ii.1.1), (ii.1.2), (ii.1.3), (ii.1.4) and (ii.1.5), all steps as disclosed above. The present invention is more preferably directed to a composition obtained or obtainable by a process comprising steps (i), (ii) and (iii), wherein step (i) comprises steps (i.1), (i.2) and (i.3), and wherein step (i.3) comprises steps (i.3.1) and (i.3.2) and wherein step (ii) comprises steps (ii.1), (ii.2), (ii.3) and (ii.4), all steps as disclosed above. The present invention is more preferably directed to a composition obtained or obtainable by a process comprising steps (i), (ii) and (iii), wherein step (i) comprises steps (i.1), (i.2) and (i.3), and wherein step (i.3) comprises steps (i.3.1) and (i.3.2), wherein step (ii) comprises steps (ii.1), (ii.2), (ii.3) and (ii.4) and wherein step (ii.1) comprises steps (ii.1.1), (ii.1.2), (ii.1.3), (ii.1.4) and (ii.1.5) all steps as disclosed above. The present invention is more preferably directed to a composition obtained or obtainable by a process comprising steps (i), (ii) and (iii), wherein step (i) comprises steps (i.1), (i.2) and (i.3), and wherein step (i.3) comprises steps (i.3.1), (i.3.2) and (1.3.3) and wherein step (ii) comprises steps (ii.1), (ii.2), (ii.3) and (ii.4), all steps as disclosed above. The present invention is more preferably directed to a composition obtained or obtainable by a process comprising steps (i), (ii) and (iii), wherein step (i) comprises steps (i.1), (i.2) and (i.3), and wherein step (i.3) comprises steps (i.3.1) (i.3.2) and (1.3.3) and wherein step (ii) comprises steps (ii.1), (ii.2), (ii.3) and (ii.4) and wherein step (ii.1) comprises steps (ii.1.1), (ii.1.2), (ii.1.3), (ii.1.4), and (ii.1.5), all steps as disclosed above.

The composition as disclosed above, obtainable or obtained by any one of the processes as disclosed above, is preferably used as a catalyst or a catalyst component, more preferably a catalyst or a catalyst component for preparing C2 to C4 olefins. More preferably, the composition as disclosed above, obtainable or obtained by any one of the processes as disclosed above is a catalyst or a catalyst component for preparing C2 to C4 olefins from a synthesis gas comprising hydrogen and carbon monoxide, wherein the C2 to C4 olefins are preferably one or more of ethene and propene, more preferably propene. Further, more preferably the composition as disclosed above is a catalyst or a catalyst component for preparing C2 to C4 olefins wherein the preparation is carried out as a one-step process. In fact, it has been surprisingly found that the present composition has a catalytic activity that is selective to the C2 to C4 olefins and particularly for the C3 olefin propene. Furthermore, the present composition as a catalyst or as catalyst component has the advantage that the process of conversion of the conversion of the synthesis gas is carried out in one step process.

Therefore the present invention is further directed to the use of a composition as disclosed above as a catalyst or as a catalyst component, preferably for preparing C2 to C4 olefins, more preferably for preparing C2 to C4 olefins from a synthesis gas comprising hydrogen and carbon monoxide. The C2 to C4 olefins are preferably one or more of ethene and propene, more preferably propene. The use of the composition of the invention further advantageously preferably entails preparing the C2 to C4 olefins as a one-step process.

Therefore the present invention is further directed to a process for preparing C2 to C4 olefins from a synthesis gas comprising hydrogen and carbon monoxide, the process comprising
(1) providing a gas stream which comprises a synthesis gas stream comprising hydrogen and carbon monoxide;
(2) providing a catalyst comprising a composition as disclosed herein above
(3) bringing the gas stream provided in (1) in contact with the catalyst provided in (2), obtaining a reaction mixture stream comprising C2 to C4 olefins.

Step (1) comprises providing a gas stream which comprises a synthesis gas stream comprising hydrogen and carbon monoxide.

With regard to the synthesis gas stream provided in (1) and the molar ratio of hydrogen relative to carbon monoxide, there is no particular restriction provided that a reaction mixture stream comprising C2 to C4 olefins is obtained. Preferably, the molar ratio of hydrogen relative to carbon monoxide is in the range of from 0.1:1 to 10:1, more preferably in the range of from 0.2:1 to 5:1, more preferably in the range of from 0.25:1 to 2:1.

Generally there is no specific restriction as to the volume-% composition of the synthesis gas stream according to (1) provided that a reaction mixture stream comprising C2 to C4 olefins is obtained. Preferably at least 99 volume-%, more preferably at least 99.5 volume-%, more preferably at least 99.9 volume-% of the synthesis gas stream according to (1) consist of hydrogen and carbon monoxide.

Generally there is no specific restriction as to the volume-% composition of the gas stream provided in (1) provided that a reaction mixture stream comprising C2 to C4 olefins is obtained.

Preferably at least 80 volume-%, more preferably at least 85 volume-%, more preferably at least 90 volume-%, more preferably from 90 to 99 volume-% of the gas stream provided in (1) consist of the synthesis gas stream. It is further contemplated that the gas stream provided in (1) preferably further comprises one or more inert gas. The inert gas preferably comprises, more preferably is one or more of nitrogen and argon. Generally there is no restriction as to the volume ratio of the one or more inter gases relative to the synthesis gas stream in the gas stream provided in (1). Preferably, the volume ratio of the one or more inter gases relative to the synthesis gas stream is in the range of from 1:20 to 1:2, more preferably in the range of from 1:15 to 1:5, more preferably in the range of from 1:12 to 1:8. With regard to the volume-% of the gas stream provided in (1) it is preferred that at least 99 volume-%, more preferably at least 99.5 volume-%, more preferably at least 99.9 volume-% of the gas stream provided in (1) consist of the synthesis gas stream and the one or more inert gases.

Step (3) comprises bringing the gas stream provided in (1) in contact with the catalyst provided in (2), obtaining a reaction mixture stream comprising C2 to C4 olefins.

According to (3), the gas stream is brought in contact with the catalyst at a temperature of the gas stream in the range of from 200 to 550° C., preferably in the range of from 250 to 525° C., more preferably in the range of from 300 to 500° C.

Further according to (3), the gas stream is brought in contact with the catalyst at a pressure of the gas stream in the range of from 10 to 40 bar(abs), preferably in the range of from 12.5 to 30 bar(abs), more preferably in the range of from 15 to 25 bar(abs).

Preferably, the reaction is carried out with the catalyst provided in (2) is comprised in a reactor tube. According to (3) the gas stream provided in (1) is brought in contact with the catalyst provided in (2). The bringing the gas stream provided in (1) in contact with the catalyst provided in (2) preferably comprises passing the gas stream as feed stream into the reactor tube and through the catalyst bed comprised in the reactor tube thereby obtaining the reaction mixture stream comprising C2 to C4 olefins. The process further comprises removing the reaction mixture stream from the reactor tube.

According to (3) the gas stream is brought in contact with the catalyst at a gas hourly space velocity in the range of from 100 to 25,000 h⁻¹, preferably in the range of from 500 to 20,000 h⁻¹, more preferably in the range of from 1,000 to 10,000 h⁻¹, wherein the gas hourly space velocity is defined as the volume flow rate of the gas stream brought in contact with the catalyst divided by the volume of the catalyst bed.

It is further preferred that prior to (3), the catalyst provided in (2) is activated. The activating of the catalyst comprises bringing the catalyst in contact with a gas stream comprising hydrogen and an inert gas, wherein preferably from 1 to 50 volume-%, more preferably from 2 to 35 volume-%, more preferably from 5 to 20 volume-% of the gas stream consist of hydrogen, and wherein the inert gas preferably comprises one or more of nitrogen and argon, more preferably nitrogen. Preferably at least 98 volume-%, more preferably at least 99 volume-%, more preferably at least 99.5 volume-% of the gas stream comprising hydrogen consist of hydrogen and the inert gas. It is further preferred that the gas stream comprising hydrogen for activating the catalyst is brought in contact with the catalyst at a temperature of the gas stream in the range of from 200 to 400° C., more preferably in the range of from 250 to 350° C., more preferably in the range of from 275 to 325° C. It is further preferred that the gas stream comprising hydrogen for activating the catalyst is brought into contact with the catalyst at a pressure of the gas stream in the range of from 1 to 50 bar(abs), more preferably in the range of from 5 to 40 bar(abs), more preferably in the range of from 10 to 30 bar(abs).

Hence preferably prior to (3), the gas stream comprising hydrogen is brought in contact with the catalyst provided in (2). This step preferably comprises passing the gas stream comprising hydrogen into the reactor tube and through the catalyst bed comprised in the reactor tube. The gas stream comprising hydrogen is brought in contact with the catalyst at a gas hourly space velocity in the range of from 500 to 15,000 h⁻¹, preferably at a gas hourly space velocity in the range of from 1,000 to 10,000 h⁻¹, more preferably in the range of from 2,000 to 8,000 h⁻¹, wherein the gas hourly space velocity is defined as the volume flow rate of the gas stream brought in contact with the catalyst divided by the volume of the catalyst bed.

The activating the catalyst further preferably comprises bringing the catalyst in contact with a synthesis gas stream comprising hydrogen and carbon monoxide, wherein in the synthesis gas stream the molar ratio of hydrogen relative to carbon monoxide is preferably in the range of from 0.1:1 to 10:1, more preferably in the range of from 0.2:1 to 5:1, more preferably in the range of from 0.25:1 to 2:1. Preferably at least 99 volume-%, more preferably at least 99.5 volume-%, more preferably at least 99.9 volume-% of the synthesis gas stream consist of hydrogen and carbon monoxide. It is further preferred that the synthesis gas stream comprising hydrogen and carbon monoxide used for activating the catalyst is the synthesis gas stream provided in (1). As to the temperature of the activating step, the synthesis gas stream comprising hydrogen and carbon monoxide is brought in contact with the catalyst at a temperature of the gas stream in the range of from 100 to 300° C., preferably in the range of from 150 to 275° C., more preferably in the range of from 200 to 250° C. As to the pressure of the activating step, the synthesis gas stream comprising hydrogen and carbon monoxide is brought in contact with the catalyst at a pressure of the gas stream in the range of from 10 to 50 bar(abs), preferably in the range of from 15 to 35 bar(abs), more preferably in the range of from 20 to 30 bar(abs). It is further preferred that the synthesis gas stream comprising hydrogen and carbon monoxide is brought in contact with the catalyst provided in (2) wherein the bringing into contact comprises passing the synthesis gas stream comprising hydrogen and carbon monoxide into the reactor tube and through the catalyst bed comprised in the reactor tube. Preferably, the gas hourly space velocity at which the synthesis gas stream comprising hydrogen and carbon monoxide is contacted with the catalyst is the in the range of from 500 to 15,000 h⁻¹, more preferably in the range of from 1,000 to 10,000 h⁻¹, more preferably in the range of from 2,000 to 8,000 h⁻¹, wherein the gas hourly space velocity is defined as the volume flow rate of the gas stream brought in contact with the catalyst divided by the volume of the catalyst bed. Further it is preferred that the bringing the synthesis gas stream comprising hydrogen and carbon monoxide in contact with the catalyst provided in (2) is carried out prior to bringing the catalyst in contact with a gas stream comprising hydrogen and an inert gas as disclosed above wherein preferably from 1 to 50 volume-%, more preferably from 2 to 35 volume-%, more preferably from 5 to 20 volume-% of the gas stream consist of hydrogen, and wherein the inert gas preferably comprises one or more of nitrogen and argon, more preferably nitrogen and wherein preferably at least 98 volume-%, more preferably at least 99 volume-%, more preferably at least 99.5 volume-% of the gas stream comprising hydrogen consist of hydrogen and the inert gas.

The process as disclosed above provides C2 to C4 olefins. The C2 to C4 olefins comprises preferably consist of ethene, propene, and a butene, wherein the butene is preferably 1-butene.

Advantageously in the reaction mixture obtained according to (3), the molar ratio of propene relative to ethene is greater than 1 and the molar ratio of ethene relative to the butene is greater than 1. Thereby propone is obtained with greater selectivity with regard to ethane and butene

Advantageously, the conversion of the synthesis gas to the C2 to C4 olefins exhibits a selectivity towards the C2 to C4 olefins of at least 30%, wherein the selectivity is determined as described in Reference Example 1.3 herein.

The present invention is further illustrated by the following embodiments and combinations of embodiments as indicated by the respective dependencies and back-references. In particular, it is noted that if a range of embodiments is mentioned, for example in the context of a term such as “The composition of any one of embodiments 1 to 4”, every embodiment in this range is meant to be disclosed for the skilled person, i.e. the wording of this term is to be understood by the skilled person as being synonymous to “The composition of any one of embodiments 1, 2, 3, and 4”.
1. A composition comprising
   a) a molding comprising a zeolitic material having framework type CHA, wherein the zeolitic material has a framework structure comprising a tetravalent element Y, a trivalent element X, and oxygen, wherein the zeolitic material further comprises one or more alkaline earth metals M; and
   b) a mixed metal oxide comprising chromium, zinc, and aluminum;
   wherein Y is one or more of Si, Ge, Sn, Ti, and Zr;
   wherein X is one or more of Al, B, Ga, and In.
2. The composition of embodiment 1, wherein Y is Si and X is Al.
3. The composition of embodiment 1 or 2, wherein in the framework structure of the zeolitic material, the molar ratio Y:X calculated as YO₂:X₂O₃ is at least 5:1, preferably in the range of from 5:1 to 50:1, preferably in the range of from 10:1 to 45:1, more preferably in the range of from 15:1 to 40:1.
4. The composition of any one of embodiments 1 to 3, wherein at least 95 weight-%, preferably at least 98 weight-%, more preferably at least 99 weight-%, more preferably at least 99.5 weight-%, more preferably at least 99.9 weight % of the framework structure of the zeolitic material consist of Y, X, O, and H.
5. The composition of any one of embodiments 1 to 4, wherein at most 1 weight-%, preferably at most 0.1 weight-%, more preferably at most 0.01 weight-%, more preferably from 0 to 0.001 weight-% of the framework structure of the zeolitic material consist of phosphorous.
6. The composition of any one of embodiments 1 to 5, wherein at least 95 weight-%, preferably at least 98 weight-%, more preferably at least 99 weight-%, more preferably at least 99.5 weight-%, more preferably at least 99.9 weight-% of the zeolitic material consist of Y, X, O, H, the one or more alkaline earth metals M and optionally an alkali metal.
7. The composition of embodiment 6, wherein the alkali metal comprises, preferably is sodium.
8. The composition of any one of embodiments 1 to 7, wherein the zeolitic material has an amount of medium acid sites, wherein the amount of medium acid sites is the amount of desorbed ammonia per mass of the calcined zeolitic material as measured according to the temperature programmed desorption of ammonia in the temperature range of from 100 to 350° C. determined according to the method as described in Reference Example 1.2, wherein the amount of medium acid sites is at least 0.7 mmol/g, preferably in the range of from 0.7 to 2 mmol/g, more preferably in the range of 0.7 to 1.1 mmol/g.
9. The composition of any of embodiments 1 to 8, wherein the zeolitic material has an amount of strong acid sites, wherein the amount of strong acid sites is the amount of desorbed ammonia per mass of the calcined zeolitic material as measured according to the temperature programmed desorption of ammonia in the temperature range of from 351 to 500° C. determined according to the method as described in Reference Example 1.2, wherein the amount of strong acid sites is less than 1.0 mmol/g, preferably less than of 0.9 mmol/g, more preferably less than 0.7 mmol/g.
10. The composition of any one of embodiment 1 to 9, wherein the molding further comprises a binder material.
11. The composition of embodiment 10, wherein the binder material comprises, preferably is one or more of graphite, silica, titania, zirconia, alumina, and a mixed oxide of two or more of silicon, titanium, zirconium, and aluminum, wherein more preferably, the binder material comprises silica, more preferably is silica.
12. The composition of any one of embodiments 1 to 11, wherein the molding has a rectangular, a triangular, a hexagonal, a square, an oval or a circular cross section, and/or preferably is in the form of a star, a tablet, a sphere, a cylinder, a strand, or a hollow cylinder.
13. The composition of embodiment 11 or 12, wherein in the molding, the weight ratio of the zeolitic material relative to the binder material is in the range of from 1:1 to 20:1, preferably in the range of from 2:1 to 10:1, more preferably in the range of from 3:1 to 5:1.
14. The composition of any one of embodiments 1 to 13, wherein the one or more alkaline earth metals M is one or more of Be, Mg, Ca, Sr and Ba, wherein the one or more alkaline earth metals M preferably comprises, more preferably is Mg.
15. The composition of any one of embodiments 1 to 14, wherein the one or more alkaline earth metals M is present in the zeolitic material at least partly in an oxidic form.
16. The composition of any one of embodiments 1 to 15, wherein the zeolitic material comprises the one or more alkaline earth metals M, calculated as elemental alkaline earth metal, in a total amount in the range of from 0.1 to 5 weight-%, preferably in the range of from 0.4 to 3 weight-%, more preferably in the range of from 0.75 to 2 weight-%, based on the weight of the zeolitic material comprised in the molding.
17. The composition of any one of embodiments 1 to 16, wherein the molding comprises micropores having a diameter of less than 2 nanometer determined according to DIN 66135 and comprises mesopores having a diameter in the range of from 2 to 50 nanometer determined according to DIN 66133.
18. The composition of any one of embodiments 1 to 17, wherein the molding comprised in the composition is a calcined molding, preferably calcined at a temperature in the range of from 400 to 600° C.
19. The composition of any one of embodiments 1 to 18, wherein the molding according to (a) is obtainable or obtained by a process comprising
   (i.1) providing a zeolitic material having framework type CHA, wherein the zeolitic material has a framework structure comprising a tetravalent element Y, a trivalent element X, and oxygen, wherein Y is one or more of Si, Ge, Sn, Ti, and Zr, wherein X is one or more of Al, B, Ga, and In;
   (i.2) impregnating the zeolitic material obtained from (i.1) with a source of the one or more alkaline earth metals;
   (i.3) preparing a molding comprising the impregnated zeolitic material obtained from (i.2) and optionally a binder material;
   wherein the process is preferably a process according to any one of embodiments 30 to 49.
20. The composition of any one of embodiments 1 to 19, wherein at least 95 weight-%, preferably at least 98 weight-%, more preferably at least 99 weight-%, more preferably at least 99.5 weight-%, more preferably at least 99.9 weight % of the molding consist of the zeolitic material and optionally the binder material according to any one of embodiments 11 to 13.
21. The composition of any one of embodiments 1 to 20, wherein at least 98 weight-%, preferably at least 99 weight-%, more preferably at least 99.5 weight-% of the mixed metal oxide consists of chromium, zinc, aluminum, and oxygen.
22. The composition of any one of embodiments 1 to 21, wherein the mixed metal oxide has a BET specific surface area in the range of from 5 to 150 m²/g, preferably in the range of from 15 to 120 m²/g, determined as described in Reference Example 1.1 herein.
23. The composition of embodiment 21 or 22, wherein in the mixed metal oxide, the weight ratio of the zinc, calculated as element, relative to the chromium, calculated as element, is in the range of from 2.5:1 to 6.0:1, preferably in the range of from 3.0:1 to 5.5:1, more preferably in the range of from 3.5:1 to 5.0:1.
24. The composition of any one of embodiments 21 to 23, wherein in the mixed metal oxide, the weight ratio of the aluminum, calculated as element, relative to the chromium, calculated as element, is in the range of from 0.1:1 to 2:1, preferably in the range of from 0.15:1 to 1.5:1, more preferably in the range of from 0.25:1 to 1:1.
25. The composition of any one of embodiments 1 to 24, wherein the weight ratio of the mixed metal oxide relative to the zeolitic material is at least 0.2:1, preferably in the range of from 0.2:1 to 5:1, more preferably in the range of from 0.5 to 3:1, more preferably in the range of from 0.9:1 to 1.5:1.
26. The composition of any one of embodiments 1 to 25, wherein at least 95 weight-%, preferably at least 98 weight-%, more preferably at least 99 weight-%, more preferably at least 99.5 weight-%, more preferably at least 99.9 weight % of the composition consist of the molding and the mixed metal oxide.
27. The composition of any one of embodiments 1 to 26, wherein the composition is a mixture of the molding and the mixed metal oxide.
28. The composition of any one of embodiments 1 to 27 as a catalyst or as a catalyst component, preferably for preparing C2 to C4 olefins, more preferably for preparing C2 to C4 olefins from a synthesis gas comprising hydrogen and carbon monoxide.
29. A process for preparing the composition according to any one of embodiments 1 to 28, the process comprising
   (i) providing a molding comprising a zeolitic material having framework type CHA, wherein the zeolitic material has a framework structure comprising a tetravalent element Y, a trivalent element X, and oxygen, wherein the zeolitic material further comprises one or more alkaline earth metals M, wherein Y is one or more of Si, Ge, Sn, Ti, and Zr, wherein X is one or more of Al, B, Ga, and In;
   (ii) providing a mixed metal oxide comprising chromium, zinc, and aluminum;
   (iii) mixing the molding provided according to (i) with the mixed metal oxide provided according to (ii), obtaining the composition.
30. The process of embodiment 29, wherein providing a molding according to (i) comprises
   (i.1) providing a zeolitic material having framework type CHA, wherein the zeolitic material has a framework structure comprising a tetravalent element Y, a trivalent element X, and oxygen, wherein Y is one or more of Si, Ge, Sn, Ti, and Zr, wherein X is one or more of Al, B, Ga, and In;
   (i.2) impregnating the zeolitic material obtained from (i.1) with a source of the one or more alkaline earth metals;
   (i.3) preparing a molding comprising the impregnated zeolitic material obtained from (i.2) and optionally a binder material.
31. The process of embodiment 30, wherein in the zeolitic material having framework type CHA provided according to (i.1), Y is Si and X is Al.
32. The process of embodiment 30 or 31, wherein in the framework structure of the zeolitic material provided according to (i.1), the molar ratio Y:X, calculated as YO₂:X₂O₃, is at least 5:1, preferably in the range of from 5:1 to 50:1, preferably in the range of from 10:1 to 45:1, more preferably in the range of from 15:1 to 40:1.
33. The process of any one of embodiments 30 to 32, wherein at least 95 weight-%, preferably at least 98 weight-%, more preferably at least 99 weight-%, more preferably at least 99.5 weight-%, more preferably at least 99.9 weight % of the framework structure of the zeolitic material provided according to (i.1) consist of Y, X, O, and H.
34. The process of any one of embodiments 30 to 33, wherein at most 1 weight-%, preferably at most 0.1 weight-%, more preferably at most 0.01 weight-%, more preferably from to 0.001 weight-% of the framework structure of the zeolitic material provided according to (i.1) consist of phosphorous.
35. The process of any one of embodiments 30 to 34, wherein at least 95 weight-%, preferably at least 98 weight-%, more preferably at least 99 weight-%, more preferably at least 99.5 weight-%, more preferably at least 99.9 weight-% of the zeolitic material provided according to (i.1) consist of Y, X, O, H, and optionally an alkali metal.
36. The process of embodiment 35, wherein the alkali metal comprises, preferably is sodium.
37. The process of any one of embodiments 30 to 36, wherein the zeolitic material provided according to (i.1) has an amount of medium acid sites, wherein the amount of medium acid sites is the amount of desorbed ammonia per mass of the calcined zeolitic material as measured according to the temperature programmed desorption of ammonia in the temperature range of from 100 to 350° C. determined according to the method as described in Reference Example 1.2, wherein the amount of medium acid sites is at least 0.7 mmol/g, preferably in the range of from 0.7 to 2 mmol/g, more preferably in the range of 0.7 to 1.1 mmol/g.
38. The process of any of embodiments 30 to 37, wherein the zeolitic material provided according to (i.1) has an amount of strong acid sites, wherein the amount of strong acid sites is the amount of desorbed ammonia per mass of the calcined zeolitic material as measured according to the temperature programmed desorption of ammonia in the temperature range of from 351 to 500° C. determined according to the method as described in Reference Example 1.2, wherein the amount of strong acid sites is less than 1.0 mmol/g, preferably less than of 0.9 mmol/g, more preferably less than 0.7 mmol/g.
39. The process of any one of embodiments 30 to 38, wherein the source of the one or more alkaline earth metals according to (i.2) is a salt of the one or more alkaline earth metals.
40. The process of embodiment, wherein the source of the one or more alkaline earth metals according to (i.2) is a salt of the one or more alkaline earth metals dissolved in one or more solvents, preferably dissolved in water.
41. The process of any one of embodiment 30 to 40, wherein impregnating the zeolitic material according to i.2 comprises one or more of wet-impregnating the zeolitic material and spray-impregnating the zeolitic material, preferably spray-impregnating the zeolitic material.
42. The process of any one of embodiments 30 to 41, wherein (i.2) further comprises calcining the zeolitic material obtained from impregnation, optionally after drying the zeolitic material obtained from impregnation, wherein the calcining is preferably carried out in a gas atmosphere having a temperature in the range of from 400 to 650° C., preferably in the range of from 450 to 600° C., wherein the gas atmosphere is preferably nitrogen, oxygen, air, lean air, or a mixture of two or more thereof, wherein, if drying is carried out prior to calcining, the drying is preferably carried out in a gas atmosphere having a temperature in the range of from 75 to 200° C., preferably in the range of from 90 to 150° C., wherein the gas atmosphere is preferably nitrogen, oxygen, air, lean air, or a mixture of two or more thereof.
43. The process of any one of embodiments 30 to 42, wherein at least 95 weight-%, preferably at least 98 weight-%, more preferably at least 99 weight-%, more preferably at least 99.5 weight-%, more preferably at least 99.9 weight-% of the impregnated zeolitic material obtained from (i.2) consist of Y, X, O, H, the one or more alkaline earth metals M, and optionally an alkali metal.
44. The process of any one of embodiments 30 to 43, wherein the zeolitic material comprises the one or more alkaline earth metals M, calculated as elemental alkaline earth metal, in a total amount in the range of from 0.1 to 5 weight-%, preferably in the range of from 0.4 to 3 weight-%, more preferably in the range of from 0.75 to 2 weight-%, based on the weight of the zeolitic material.
45. The process of any one of embodiments 30 to 44, wherein preparing a molding according to (i.3) comprises
   (i.3.1) preparing a mixture of the impregnated zeolitic material obtained from (i.2) and a source of a binder material;
   (i.3.2) subjecting the mixture prepared according to (i.3.1) to shaping.
46. The process of embodiment 45, wherein the source of a binder material is one or more of a source of graphite, a source of silica, a source of titania, a source of zirconia, a source of alumina and a source of a mixed oxide of two or more of silicon, titanium, zirconium and aluminum, wherein the source of a binder material preferably comprises, more preferably is a source of silica, wherein the source of silica preferably comprises one or more of a colloidal silica, a fumed silica, and a tetraalkoxysilane, more preferably comprises a colloidal silica.
47. The process of embodiment 45 or 46, wherein the mixture prepared according to (i.3.1) further comprises a pasting agent, wherein the pasting agent preferably comprises one or more of an organic polymer, an alcohol and water, wherein the organic polymer is preferably one or more of a carbohydrate, a polyacrylate, a polymethacrylate, a polyvinyl alcohol, a polyvinylpyrrolidone, a polyisobutene, a polytetrahydrofuran, and a polyethlyene oxide, wherein the carbohydrate is preferably one or more of cellulose and cellulose derivative, wherein the cellulose derivative is preferably a cellulose ether, more preferably a hydroxyethyl methylcellulose, wherein more preferably, the pasting agent comprises one or of water and a carbohydrate.
48. The process of any one of embodiments 45 to 47, wherein subjecting to shaping according to (i.3.2) comprises subjecting the mixture prepared according to (i.3.1) to spray-drying, to spray-granulation, or to extrusion, preferably to extrusion.
49. The process of any one of embodiments 45 to 48, further comprising
   (i.3.3) calcining the molding obtained from (i.3.2), optionally after drying, wherein the calcining is preferably carried out in a gas atmosphere having a temperature in the range of from 400 to 650° C., preferably in the range of from 450 to 600° C., wherein the gas atmosphere is preferably nitrogen, oxygen, air, lean air, or a mixture of two or more thereof, wherein, if drying is carried out prior to calcining, the drying is preferably carried out in a gas atmosphere having a temperature in the range of from 75 to 200° C., preferably in the range of from 90 to 150° C., wherein the gas atmosphere is preferably nitrogen, oxygen, air, lean air, or a mixture of two or more thereof.
50. The process of any one of embodiment 29 to 49, wherein providing the mixed metal oxide according to (ii) comprises
(ii.1) co-precipitating a precursor of the mixed metal oxide from sources of the chromium, the zinc, and the aluminum;
(ii.2) washing the precursor obtained from (ii.1);
(ii.3) drying the washed precursor obtained from (ii.2);
(ii.4) calcining the washed precursor obtained from (ii.3).
51. The process of embodiment 50, wherein co-precipitating a precursor according to (ii.1) comprises
   (ii.1.1) preparing a mixture comprising water and the sources of the chromium, the zinc, and the aluminum, wherein the sources of the chromium, the zinc, and the aluminum preferably comprises one or more of a chromium salt, a zinc salt, and an aluminum salt, wherein more preferably, the chromium salt is a chromium nitrate, preferably a chromium(III) nitrate, the zinc salt is a zinc nitrate, preferably a Zn(II) nitrate, and the aluminum salt is an aluminum nitrate, preferably an aluminum(III) nitrate;
   (ii.1.2) adding a precipitation agent to the mixture prepared according to (ii.1.1), wherein the precipitation agent preferably comprises an ammonium carbonate, more preferably an ammonium carbonate dissolved in water;
   (ii.1.3) subjecting the mixture obtained from (ii.1.2) to heating to a temperature of the mixture in the range of from 50 to 90° C., preferably in the range of from 60 to 80° C., and keeping the mixture at this temperature for a period of time, wherein the period of time is preferably in the range of from 0.1 to 12 h, more preferably in the range of from 0.5 to 6 h;
   (ii.1.4) optionally drying the mixture obtained from (ii.1.3), preferably in a gas atmosphere having a temperature in the range of from 75 to 200° C., preferably in the range of from 90 to 150° C., wherein the gas atmosphere is preferably oxygen, air, lean air, or a mixture of two or more thereof;
   (ii.1.5) calcining the mixture obtained from (ii.1.3) or from (ii.1.4), preferably from (ii.1.4), preferably in a gas atmosphere having a temperature in the range of from 300 to 900° C., preferably in the range of from 350 to 800° C., wherein the gas atmosphere is preferably oxygen, air, lean air, or a mixture of two or more thereof, obtaining the mixed metal oxide.
52. The process of embodiment 51, wherein according to (ii.1.5), the mixture is calcined at a temperature in the range of from 350 to 440° C., preferably in the range of from 375 to 425° C.
53. The process of embodiment 51, wherein according to (ii.1.5), the mixture is calcined at a temperature in the range of from 450 to 550° C., preferably in the range of from 475 to 525° C.
54. The process of embodiment 51, wherein according to (ii.1.5), the mixture is calcined at a temperature in the range of from 700 to 800° C., preferably in the range of from 725 to 775° C.
55. The process of any one of embodiment 51 to 54, wherein in the mixture prepared in (ii.1.1), the weight ratio of the zinc, calculated as element, relative to the chromium, calculated as element, is in the range of from 2.5:1 to 6:1, preferably in the range of from 3.0:1 to 5.5:1, more preferably in the range of from 3.5:1 to 5:1.
56. The process of any one of embodiment 51 to 55, wherein in the mixture prepared in (ii.1.1), the weight ratio of the aluminum, calculated as element, relative to the chromium, calculated as element, is in the range of from 0.1:1 to 2:1, preferably in the range of from 0.15:1 to 1.5:1, more preferably in the range of from 0.25:1 to 1:1.
57. The process of anyone of embodiments 51 to 56, wherein in the mixture prepared in (ii.1.1), the weight ratio of the zinc, calculated as element, relative to the chromium, calculated as element, is in the range of from 3.5:1 to 5:1 and the weight ratio of the aluminum, calculated as element, relative to the chromium, calculated as element, is in the range of from 0.25:1 to 1:1.
58. A molding, obtainable or obtained by a process according to any one of embodiments 30 to 49.
59. A mixed metal oxide, obtainable or obtained by a process according to any one of embodiments 50 to 56.
60. A composition, obtainable or obtained by a process according to any one of embodiments 29 to 56, preferably as a catalyst or as a catalyst component, more preferably for preparing C2 to C4 olefins, more preferably for preparing C2 to C4 olefins from a synthesis gas comprising hydrogen and carbon monoxide, wherein the C2 to C4 olefins is preferably one or more of ethene and propene, more preferably propene, wherein preparing the C2 to C4 olefins is preferably carried out as a one-step process.
61. Use of a composition according to any one of embodiments 1 to 28 or 60 as a catalyst or as a catalyst component, preferably for preparing C2 to C4 olefins, more preferably for preparing C2 to C4 olefins from a synthesis gas comprising hydrogen and carbon monoxide, wherein the C2 to C4 olefins is preferably one or more of ethene and propene, more preferably propene, wherein preparing the C2 to C4 olefins is preferably carried out as a one-step process.
62. A process for preparing C2 to C4 olefins from a synthesis gas comprising hydrogen and carbon monoxide, the process comprising
   (1) providing a gas stream which comprises a synthesis gas stream comprising hydrogen and carbon monoxide;
   (2) providing a catalyst comprising a composition according to any one of embodiments 1 to 28 or 60.
   (3) bringing the gas stream provided in (1) in contact with the catalyst provided in (2), obtaining a reaction mixture stream comprising C2 to C4 olefins.
63. The process of embodiment 62, wherein in the synthesis gas stream provided in (1), the molar ratio of hydrogen relative to carbon monoxide is in the range of from 0.1:1 to 10:1, preferably in the range of from 0.2:1 to 5:1, more preferably in the range of from 0.25:1 to 2:1.
64. The process of embodiment 62 or 63, wherein at least 99 volume-%, preferably at least 99.5 volume-%, more preferably at least 99.9 volume-% of the synthesis gas stream according to (1) consist of hydrogen and carbon monoxide.
65. The process of any one of embodiments 62 to 64, wherein at least 80 volume-%, preferably at least 85 volume-%, more preferably at least 90 volume-%, more preferably from 90 to 99 volume-% of the gas stream provided in (1) consist of the synthesis gas stream.
66. The process of any one of embodiments 62 to 65, wherein the gas stream provided in (1) further comprises one or more inert gas preferably comprising, more preferably being one or more of nitrogen and argon.
67. The process of embodiment 66, wherein in the gas stream provided in (1), the volume ratio of the one or more inter gases relative to the synthesis gas stream is in the range of from 1:20 to 1:2, preferably in the range of from 1:15 to 1:5, more preferably in the range of from 1:12 to 1:8.
68. The process of embodiment 66 or 67, wherein at least 99 volume-%, preferably at least 99.5 volume-%, more preferably at least 99.9 volume-% of the gas stream provided in (1) consist of the synthesis gas stream and the one or more inert gases.
69. The process of any one of embodiments 62 to 68, wherein according to (3), the gas stream is brought in contact with the catalyst at a temperature of the gas stream in the range of from 200 to 550° C., preferably in the range of from 250 to 525° C., more preferably in the range of from 300 to 500° C.
70. The process of any one of embodiments 62 to 69, wherein according to (3), the gas stream is brought in contact with the catalyst at a pressure of the gas stream in the range of from 10 to 40 bar(abs), preferably in the range of from 12.5 to 30 bar(abs), more preferably in the range of from 15 to 25 bar(abs).
71. The process of any one of embodiments 62 to 70, wherein the catalyst provided in (2) is comprised in a reactor tube, and wherein bringing the gas stream provided in (1) in contact with the catalyst provided in (2) according to (3) comprises passing the gas stream as feed stream into the reactor tube and through the catalyst bed comprised in the reactor tube, obtaining the reaction mixture stream comprising C2 to C4 olefins, said process further comprising removing the reaction mixture stream from the reactor tube.
72. The process of embodiment 71, wherein according to (3), the gas stream is brought in contact with the catalyst at a gas hourly space velocity in the range of from 100 to 25,000 h⁻¹, preferably in the range of from 500 to 20,000 h⁻¹, more preferably in the range of from 1,000 to 10,000 h⁻¹, wherein the gas hourly space velocity is defined as the volume flow rate of the gas stream brought in contact with the catalyst divided by the volume of the catalyst bed.
73. The process of any one of embodiments 62 to 72, wherein prior to (3), the catalyst provided in (2) is activated.
74. The process of embodiment 73, wherein activating the catalyst comprises bringing the catalyst in contact with a gas stream comprising hydrogen and an inert gas, wherein preferably from 1 to 50 volume-%, more preferably from 2 to 35 volume-%, more preferably from 5 to 20 volume-% of the gas stream consist of hydrogen, and wherein the inert gas preferably comprises one or more of nitrogen and argon, more preferably nitrogen.
75. The process of embodiment 74, wherein at least 98 volume-%, preferably at least 99 volume-%, more preferably at least 99.5 volume-% of the gas stream comprising hydrogen consist of hydrogen and the inert gas.
76. The process of embodiment 74 or 75, wherein the gas stream comprising hydrogen is brought in contact with the catalyst at a temperature of the gas stream in the range of from 200 to 400° C., preferably in the range of from 250 to 350° C., more preferably in the range of from 275 to 325° C.
77. The process of any one of embodiments 74 or 76, wherein the gas stream comprising hydrogen is brought in contact with the catalyst at a pressure of the gas stream in the range of from 1 to 50 bar(abs), preferably in the range of from 5 to 40 bar(abs), more preferably in the range of from 10 to 30 bar(abs).
78. The process of any one of embodiments 74 to 77, wherein the catalyst provided in (2) is comprised in a reactor tube, and wherein prior to (3), bringing the gas stream comprising hydrogen in contact with the catalyst provided in (2) comprises passing the gas stream comprising hydrogen into the reactor tube and through the catalyst bed comprised in the reactor tube.
79. The process of embodiment 78, wherein the gas stream comprising hydrogen is brought in contact with the catalyst at a gas hourly space velocity in the range of from 500 to 15,000 h⁻¹, preferably in the range of from 1,000 to 10,000 h⁻¹, more preferably in the range of from 2,000 to 8,000 h⁻¹, wherein the gas hourly space velocity is defined as the volume flow rate of the gas stream brought in contact with the catalyst divided by the volume of the catalyst bed.
80. The process of any one of embodiments 73 to 79, wherein activating the catalyst further comprises bringing the catalyst in contact with a synthesis gas stream comprising hydrogen and carbon monoxide, wherein in the synthesis gas stream the molar ratio of hydrogen relative to carbon monoxide is preferably in the range of from 0.1:1 to 10:1, more preferably in the range of from 0.2:1 to 5:1, more preferably in the range of from 0.25:1 to 2:1, wherein preferably at least 99 volume-%, more preferably at least 99.5 volume-%, more preferably at least 99.9 volume-% of the synthesis gas stream according to (1) consist of hydrogen and carbon monoxide.
81. The process of embodiment 80, wherein the synthesis gas stream comprising hydrogen and carbon monoxide used for activating the catalyst is the synthesis gas stream provided in (1).
82. The process of embodiment 80 or 81, wherein for activating the catalyst, the synthesis gas stream comprising hydrogen and carbon monoxide is brought in contact with the catalyst at a temperature of the gas stream in the range of from 100 to 300° C., preferably in the range of from 150 to 275° C., more preferably in the range of from 200 to 250° C.
83. The process of any one of embodiments 80 or 82, wherein for activating the catalyst, the synthesis gas stream comprising hydrogen and carbon monoxide is brought in contact with the catalyst at a pressure of the gas stream in the range of from 10 to 50 bar(abs), preferably in the range of from 15 to 35 bar(abs), more preferably in the range of from 20 to 30 bar(abs).
84. The process of any one of embodiments 80 to 83, wherein the catalyst provided in (2) is comprised in a reactor tube, and wherein for activating the catalyst, bringing the synthesis gas stream comprising hydrogen and carbon monoxide in contact with the catalyst provided in (2) comprises passing the synthesis gas stream comprising hydrogen and carbon monoxide into the reactor tube and through the catalyst bed comprised in the reactor tube.
85. The process of embodiment 84, wherein the synthesis gas stream comprising hydrogen and carbon monoxide is brought in contact with the catalyst at a gas hourly space velocity in the range of from 500 to 15,000 h⁻¹, preferably in the range of from 1,000 to 10,000 h⁻¹, more preferably in the range of from 2,000 to 8,000 h⁻¹, wherein the gas hourly space velocity is defined as the volume flow rate of the gas stream brought in contact with the catalyst divided by the volume of the catalyst bed.
86. The process of any one of embodiments 80 to 85, wherein for activating the catalyst prior to (3), bringing the synthesis gas stream comprising hydrogen and carbon monoxide in contact with the catalyst provided in (2) is carried out prior to bringing the catalyst in contact with a gas stream comprising hydrogen and an inert gas according to any one of embodiments 74 to 79.
87. The process of any one of embodiments 62 to 86, wherein the C2 to C4 olefins comprise, preferably consist of ethene, propene, and a butene, wherein the butene is preferably 1-butene.
88. The process of embodiment 87 wherein in the reaction mixture obtained according to (3), the molar ratio of propene relative to ethene is greater than 1 and the molar ratio of ethene relative to the butene is greater than 1.
89. The process of any one of embodiments 62 to 88, wherein the conversion of the synthesis gas to the C2 to C4 olefins exhibits a selectivity towards the C2 to C4 olefins of at least 30%, wherein the selectivity is determined as described in Reference Example 1.3 herein.

The present invention is further illustrated by the following Examples, Comparative Examples, and Reference Examples.

### EXAMPLES

### Reference Example 1: Analytical Methods

### Reference Example 1.1: Determination of the BET Specific Surface Area

The BET specific surface area was determined via nitrogen physisorption at 77 K according to the method disclosed in DIN 66131.

### Reference Example 1.2: Temperature Programmed Desorption of Ammonia (NH₃-TPD)

The temperature-programmed desorption of ammonia (NH₃-TPD) was conducted in an automated chemisorption analysis unit (Micromeritics AutoChem II 2920) having a thermal conductivity detector. Continuous analysis of the desorbed species was accomplished using an online mass spectrometer (OmniStar QMG200 from Pfeiffer Vacuum). The sample (0.1 g) was introduced into a quartz tube and analyzed using the program described below. The temperature was measured by means of a Ni/Cr/Ni thermocouple immediately above the sample in the quartz tube. For the analyses, He of purity 5.0 was used. Before any measurement, a blank sample was analyzed for calibration.
1. Preparation: Commencement of recording; one measurement per second. Wait for 10 minutes at 25° C. and a He flow rate of 30 cm³/min (room temperature (about 25° C.) and 1 atm); heat up to 600° C. at a heating rate of 20 K/min; hold for 10 minutes. Cool down under a He flow (30 cm³/min) to 100° C. at a cooling rate of 20 K/min (furnace ramp temperature); Cool down under a He flow (30 cm³/min) to 100° C. at a cooling rate of 3 K/min (sample ramp temperature).
2. Saturation with NH₃: Commencement of recording; one measurement per second. Change the gas flow to a mixture of 10% NH₃ in He (75 cm³/min; 100° C. and 1 atm) at 100° C.; hold for 30 minutes.
3. Removal of the excess: Commencement of recording; one measurement per second. Change the gas flow to a He flow of 75 cm³/min (100° C. and 1 atm) at 100° C.; hold for 60 min.
4. NH₃-TPD: Commencement of recording; one measurement per second. Heat up under a He flow (flow rate: 30 cm³/min) to 600° C. at a heating rate of 10 K/min; hold for 30 minutes.
5. End of measurement.

Desorbed ammonia was measured by means of the online mass spectrometer, which demonstrates that the signal from the thermal conductivity detector was caused by desorbed ammonia. This involved utilizing the m/z=16 signal from ammonia in order to monitor the desorption of the ammonia. The amount of ammonia adsorbed (mmol/g of sample) was ascertained by means of the Micromeritics software through integration of the TPD signal with a horizontal baseline.

### Reference Example 1.3: Determination of Selectivities and Yields

The selectivity of a given product compound, in %, referred to in the following as “S_{N}_SubstanceA”, is a normalized selectivity S_{N} and is calculated as follows:

S_{N}_SubstanceA/%=S_SubstanceA/%*Fact_normS

wherein

S_SubstanceA/%=selectivity of substance A

Fact_normS=normalization factor, used to achieve a sum of the selectivities of 100%

a) S_SubstanceA

The selectivity of substance A, S_SubstanceA, is defined as

S_SubstanceA/%=(Y_SubstanceA/X_CO(IntStd))*100

wherein
Y_SubstanceA=yield of substance A
X_CO(IntStd)=conversion of CO calculated based on an internal standard, in the present case an inert liner (Argon)

a.1) Y_SubstanceA

The yield of substance A, Y_SubstanceA, is defined

Y_SubstanceA/%=(R(C)_SubstanceA/R(C)_CO_in)*100

wherein
R(C)_SubstanceA=the rate of carbon of substance A, determined in g/h via gas chromatography
R(C)_CO_in =the rate of carbon monoxide CO which is fed to the reactor, determined in (g carbon)/h

a.2) X_CO(IntStd)

The conversion of CO, X_CO(IntStd), is defined as

X_CO(IntStd)=(1−(RA_CO/Arout)/(RA_CO/AroutRef))*100

wherein
RA_CO/Arout=rate of CO determined via gas chromatography, divided by the rate of the inert liner Ar determined via GC
RA_CO/AroutRef=rate of CO/reference determined via gas chromatography, divided by the rate of inert liner Ar/reference determined via gas chromatography (i.e. rate of CO at the inlet divided by rate of Ar at the inlet

b) Fact_normS

The normalization factor, Fact_normS, is defined as

Fact_normS=100/((Sum of all S)−(S_starting material))

wherein
Sum of all S=sum of all selectivities measured at the outlet of the reactor (which would include the selectivities of starting material at the out let of the conversion is not 100%)
S_starting material=selectivites of the starting materials (if conversion is 100%, the value would be 0%)

### Reference Example 1.4: Determination of XRD Patterns

The crystallinity of the zeolitic materials was determined by XRD analysis. The data were collected using a standard Bragg-Brentano diffractometer with a Cu—X-ray source and an energy dispersive point detector. The angular range of 2° to 70° (2 theta) was scanned with a step size of 0.02°, while the variable divergence slit was set to a constant opening angle of 0.3°. The data were then analyzed using TOPAS V5 software, wherein the sharp diffraction peaks were modeled using PONKCS phases for AEI and FAU and the crystal structure for CHA. The model was prepared according to Madsen I C, Scarlett NVY (2008) Quantitative phase analysis. In: Dinnebier R E, Billinge S J L (eds) Powder diffraction: theory and practice. The Royal Society of Chemistry, Cambridge, pp. 298-331. This was refined to fit the data. An independent peak was inserted at the angular position 28°. This was used to describe the amorphous content. The crystalline content describes the intensity of the crystalline signal to the total scattered intensity. Included in the model were also a linear background, Lorentz and polarization corrections, lattice parameters, space group and crystallite size.

### Reference Example 2: Preparation of a Molding Comprising a Zeolitic Material SAPO-34

a) Providing a SAPO-34 Zeolitic Material

The SAPO-34 zeolitic material was purchased from the company Zeochem.

b) Preparing an Extrudate of the SAPO-34 Zeolitic Material

Materials Used:

| | |
|---|---|
| SAPO-34 zeolitic material, according to a) above: | 72 g |
| De-ionized water: | 25 ml |
| Ludox ®AS40 (Grace; colloidal silica; | 45 g |
| aqueous solution, 40 weight-%): | |
| Walocel 5 % | 90.0 g |

The zeolitic material, the Ludox® and the PEO were kneaded for 1 h with gradual addition of the deionized water. The paste obtained was extruded and strands of a diameter of 1 mm diameter were formed. The strands were dried at 120° C. and then calcined for 5 hours at 500° C. 60 g of product were obtained.

### Reference Example 2.1: Preparation of a Molding Comprising a 0.5 Weight-% Mg-SAPO-A Zeolitic Material

a) Providing a SAPO-34 zeolitic material.

The SAPO-34 zeolitic material was purchased from the company Zeochem according to Reference Example 2a) above.

b) Providing a Mg-SAPO-34 Zeolitic Material

| | |
|---|---|
| SAPO-34 zeolitic material of a) | 80 g |
| Mg(NO₃)₂ × H₂O | 4.1 g |
| Deionized water | 55 g |

Mg(NO₃)₂×H₂O was dissolved in water and homogenized. The solution was added dropwise to the zeolitic material comprised in a beaker. The impregnated zeolite was transferred in a porcelain bowl. The material was dried at 120° C. and then calcined for 5 hours at 500° C. 80 g of product were obtained. Elemental analysis of the zeolitic material showed a Mg content of 0.5 weight-%. The NH3-TPD analysis performed according to Reference Example 1.2 showed the following peaks (see Table 1 below).

TABLE 1
Results of the NH3-TPD analysis

| | Temperature | | Peak |
|---|---|---|---|
| Peak | at maximum/ | Quantity/ | concentration/ |
| number | ° C. | mmol/g | % |
| 1 | 189.3 | 0.123 | 0.91 |
| 2 | 341.8 | 0.144 | 0.81 |
| 3 | 544.6 | 0.039 | 0.67 |

The plot of the NH3-TPD analysis is shown in FIG. 1.

c) Preparing a Molding Comprising the 0.5 Weight-% Mg-SAPO-34 Zeolitic Material

Materials Used:

| | |
|---|---|
| 0.5 % Mg-SAPO-34 zeolitic material, according to a) above: | 75 g |
| Ludox ® AS40 (Grace; colloidal silica; aqueous solution, | 46.9 g |
| 40 weight-%): | |
| Walocel ® 5% | 93.8 g |

The zeolitic material, the Ludox® and the Walocel were kneaded for 1 h (with no addition of water). The material obtained was extruded and strands of a diameter of 1 mm diameter were formed. The strands were dried hours at 120° C. and then calcined for 5 hours at 500° C. 60 g of product were obtained.

### Reference Example 2.2: Preparation of a Molding Comprising a 1.1 Weight-% Mg-SAPO-34 Zeolitic Material

a) Providing a SAPO-34 Zeolitic Material.

The SAPO-34 zeolitic material was purchased from the company Zeochem according to Reference Example 2a) above.

b) Providing a Mg-SAPO-34 Zeolitic Material

| | |
|---|---|
| SAPO-34 zeolitic material of a) | 80 g |
| Mg(NO₃)₂ × H₂O | 8.8 g |
| Deionized water | 55 g |

Mg(NO₃)₂×H₂O was dissolved in water and homogenized. The solution was added dropwise to the zeolitic material comprised in a beaker. The impregnated zeolite was transferred in a porcelain bowl. The material was dried at 120° C. and then calcined for 5 hours at 500° C. 80 g of product were obtained. Elemental analysis of the zeolitic material showed a Mg content of 1.1 weight-%. The NH3-TPD analysis performed according to Reference Example 1.2 shows the following peaks (see Table 2 below).

TABLE 2
Results of the NH3-TPD analysis

| | Temperature at | | |
|---|---|---|---|
| | maximum | Quantity/ | Peak concentration/ |
| Peak number | (° C. | mmol/g | % |
| 1 | 178.3 | 0.030 | 0.70 |
| 2 | 314.7 | 0.031 | 0.68 |

The plot of the NH3-TPD analysis is shown in FIG. 2.

c) Preparing an Extrudate Comprising the 1.1 Weight-% Mg-SAPO-34 Zeolitic Material

Materials Used:

| | |
|---|---|
| 1.1% Mg-SAPO-34 zeolitic material, according to a) above: | 75 g |
| Ludox ® AS40 (Grace; colloidal silica; aqueous solution, | 46.9 g |
| 40 weight-%): | |
| Walocel 5% | 93.8 g |

The zeolitic material, the Ludox® and the Walocel were kneaded for 1 h (with no addition of water). The material obtained was extruded and strands of 1 mm diameter were formed. The strands obtained were dried hours at 120° C. and then calcined for 5 hours at 500° C. 60 g of product were obtained.

### Reference Example 2.3: Preparation of a Molding Comprising a 2 Weight-% Mg-SAPO-34 Zeolitic Material

a) Providing a SAPO-34 Zeolitic Material.

The SAPO-34 zeolitic material was purchased from the company Zeochem according to Reference Example 2a) above.

b) Providing a Mg-SAPO-34 Zeolitic Material

| | |
|---|---|
| SAPO-34 zeolitic material of a) | 80 g |
| Mg(NO₃)₂ × H₂O | 16.8 g |
| Deionized water | 55 g |

Mg(NO₃)₂×H₂O was dissolved in water and homogenized. The solution was added dropwise to the zeolitic material comprised in a beaker. The impregnated zeolite was transferred in a porcelain bowl. The material was dried at 120° C. and then calcined for 5 hours at 500° C. 80 g of product were obtained. Elemental analysis of the zeolitic material showed a Mg content of 2 weight-%. The NH3-TPD analysis performed as disclosed in Reference Example 1.2 showed the following peaks (see Table 3 below).

TABLE 3
Results of the NH3-TPD analysis

| Peak | Temperature at | Quantity/ | Peak concentration/ |
|---|---|---|---|
| number | maximum/° C. | mmol/g | % |
| 1 | 178.8 | 0.031 | 0.71 |
| 2 | 301.2 | 0.041 | 0.69 |

The plot of the NH3TPD analysis is shown in FIG. 3.

c) Preparing an Extrudate Comprising the 2 Weight-% Mg-SAPO-34 Zeolitic Material

Materials Used:

| | |
|---|---|
| 2% Mg-SAPO-34 zeolitic material, according to a) above: | 75 g |
| Ludox ® AS40 (Grace; colloidal silica; aqueous solution, | 46.9 g |
| 40 weight-%): | |
| Walocel 5% | 93.8 g |

The zeolitic material, the Ludox® and the Walocel were kneaded for 1 h (with no addition of water). The material obtained was extruded and strands of 1 mm diameter were formed. The strands obtained were dried hours at 120° C. and then calcined for 5 hours at 500° C. 60 g of product were obtained.

### Reference Example 3: Preparation of a Molding Comprising a Zeolitic Material SAPO-34

a) Preparing a SAPO-34 Zeolitic Material

Materials Used:

| | |
|---|---|
| Al₂O₃ (Pural ® SB) | 7.97 g |
| De-ionized water | 88.11 g |
| 85% H₃PO₄ | 20.19 g |
| Ludox ® AS30 | 10.53 g |
| Triethanolamine (TEA) | 33.20 g |

The water was provided in a beaker provided with a blade stirrer. The 85% H₃PO₄ and the TEA were slowly added. Al₂O₃ was added under stirring. The mixture was heated at 50° C. and then stirred for 1 h. Then, thereto Ludox® AS30 was added and the mixture was subjected to stirring for 30 min. The resulting mixture was heated to a temperature of 190° C. hours in an autoclave. The product was then crystallized at 190° C. for 24 h without stirring. The product was subjected to centrifugal separation and washing with water (pH=7) and then dried at 120° C. The product was calcined at 500° C. for 5 h in air to obtain 59 g of the zeolitic material.

b) Preparing an Extrudate of the SAPO-34 Zeolitic Material

Materials Used:

| | |
|---|---|
| SAPO-34 zeolitic material, according to a) above: | 59 g |
| De-ionized water: | 30 ml |
| Ludox ® AS40 (Grace; colloidal silica; | 37 g |
| aqueous solution, 40 weight-%): | |
| Walocel 5% | 73.8 g |

The zeolitic material, the Ludox and the Walocel were kneaded for 1 h with gradual addition of the deionized water. The paste obtained was extruded and strands of a diameter of 1 mm were formed. The strands were dried at 120° C. and then calcined for 5 hours at 500° C.

The NH3-TPD analysis performed according to Reference Example 1.2 showed the following peaks (Table 4).

TABLE 4
Results of the NH3-TPD analysis

| | Temperature at | | Peak |
|---|---|---|---|
| | maximum/ | Quantity/ | concentration/ |
| Peak number | ° C. | mmol/g | % |
| 1 | 201.4 | 0.286 | 1.35 |
| 2 | 424.5 | 0.224 | 1.11 |
| 3 | 334.9 | 0.297 | 0.99 |

The plot of the NH3-TPD analysis is shown in FIG. 4

### Reference Example 4: Preparation of a Molding Comprising a Zeolitic Material Having Framework Type CHA

a) Providing a CHA Zeolitic Material

A zeolitic material having framework type CHA was prepared as follows:

2,040 kg of water were placed in a stirring vessel and 3,924 kg of a solution of 1-adamantyltrimethyl ammoniumhydroxide (20 weight-% aqueous solution) were added thereto under stirring. 415.6 kg of a solution of sodium hydroxide (20 weight-% aqueous solution) were then added, followed by 679 kg of aluminum triisopropylate (Dorox® D 10, Ineos), after which the resulting mixture was stirred for 5 min. 7800.5 kg of a solution of colloidal silica (40 weight-% aqueous solution; Ludox® AS 40, Sigma Aldrich) were then added and the resulting mixture stirred for 15 min before being transferred to an autoclave. 1,000 kg of distilled water used for washing out the stirring vessel were added to the mixture in the autoclave, and the final mixture was then heated under stirring for 19 h at 170° C. The solid product was then filtered off and the filter cake washed with distilled water. The resulting filter cake was then dispersed in distilled water in a spray dryer mix tank to obtain a slurry with a solids concentration of approximately 24 weight-% and then spray dried, wherein the inlet temperature was set to 477-482° C. and the outlet temperature was measured to be 127-129° C., thus affording a spray dried powder of a zeolite having the CHA framework structure. The resulting material had a particle size distribution affording a Dv10 value of 1.4 micrometer, a Dv50 value of 5.0 micrometer, and a Dv90 value of 16.2 micrometer. The material displayed a BET specific surface area of 558 m²/g, a silica to alumina ratio of 34, a crystallinity of 105% as determined by powder X-ray diffraction. The sodium content of the product was determined to be 0.75 weight-% calculated as Na₂O.

b) Preparing an Extrudate of the CHA Zeolitic Material

Materials Used:

| | |
|---|---|
| CHA zeolitic material, according to a) above: | 75 g |
| De-ionized water: | 65 ml |
| Ludox ® AS40 (Grace; colloidal silica; aqueous | 46.7 g |
| solution, 40 weight-%): | |
| Walocel 5% | 93.8 g |

The zeolitic material, the Ludox® and the Walocel were kneaded for 1 h with gradual addition of the deionized water. The paste obtained was extruded and strands of a diameter of 1 mm were formed. The strands were dried at 120° C. and then calcined for 5 hours at 500° C. 65 g of product were obtained.

### Reference Example 5: Preparation of a Mixed Oxide of Cr, Zn, and Al

### Reference Example 5.1: Preparation at 400° C.

The mixed oxide was prepared by co-precipitation. 43.68 g of Zn(NO₃)₂×6H₂O (Sigma-Aldrich, purity 99%), 16.8 g Cr(NO₃)₃×9H₂O (Sigma-Aldrich, purity 99%) and 15.75 g Al(NO₃)₃×9H₂O (Fluka, purity 98%) were dissolved in 500 ml distilled water at 70° C. under stirring. A 20% aqueous solution of (NH₄)₂CO₃ was used as precipitation agent. The precipitation agent was added dropwise to the metal solution within 60 min so that the final pH of the solution was 7. After addition of the precipitation agent the mixture was stirred for 180 min at 70° C. The resulting precipitate was filtered and washed with distilled water until the nitrate-test strip indicated that the washing water was free of nitrate ions. The sample was then dried at 110° C. for 15 h under static air, and subsequently calcined at 400° C. for 1 h under static air. The calcined sample was then sieved to obtain the particle fraction needed for testing. The resulting chemical composition of the calcined sample, determined by elemental analysis, was 6.9 weight-% Al, 12.6 weight-% Cr and 51 weight-% Zn. The N₂-BET surface area of the calcined powder determined according to Reference Example 1.1 was 107 m²/g. The XRD pattern of the calcined powder determined according to Reference Example 1.4 showed broad reflections which were assigned to zyncite-like phase ZnO and gahnite-like phase Zn(Al_{1.06}Cr_{0.94})O₄. The XRD pattern is shown in FIG. 8.

### Reference Example 5.2: Preparation at 500° C.

The mixed oxide was prepared by co-precipitation. 8.2 g of Zn(NO₃)₂×6H₂O (Sigma-Aldrich, purity 99%), 22.4 g Cr(NO₃)₃×9H₂O (Sigma-Aldrich, purity 99%) and 21.0 g Al(NO₃)₃×9H₂O (Fluka, purity 98%) were dissolved in 500 ml distilled water at 70° C. under stirring. A 20 wt % aqueous solution of (NH₄)₂CO₃ was used as precipitation agent. The precipitation agent was added dropwise to the metal solution in-between 63 min so that the final pH of the solution was 7. After addition of the precipitation agent the mixture was stirred for 180 min at 70° C. The resulting precipitate was filtered and washed with distilled water until the nitrate-test strip indicated that the washing water was free of nitrate ions. The sample was then dried at 110° C. for 15 h under static air, and subsequently calcined at 500° C. for 1 h under static air. The calcined sample was then sieved to obtain the particle fraction needed for testing. The resulting chemical composition of the calcined catalyst, determined by elemental analyses, was 6.9 weight-% Al, 12.5 weight-% Cr and 53 weight-% Zn. The N₂-BET surface area of the calcined powder determined according to Reference Example 1.1 was 79 m²/g. The XRD pattern of the calcined powder determined according to Reference Example 1.4 showed broad reflections which were assigned to zyncite-like phase ZnO and gahnite-like phase Zn(Al_{1.06}Cr_{0.94})O₄. The XRD pattern is shown in FIG. 9.

### Reference Example 5.3: Preparation at 750° C.

The mixed oxide was prepared by co-precipitation. 58.2 g of Zn(NO₃)₂×6H₂O (Sigma-Aldrich, purity 99%), 22.4 g Cr(NO₃)₃×9H₂O (Sigma-Aldrich, purity 99%) and 21.0 g Al(NO₃)₃×9H₂O (Fluka, purity 98%) were dissolved in 500 ml distilled water at 70° C. under stirring. A 20 wt % aqueous solution of (NH₄)₂CO₃ was used as precipitation agent. The precipitation agent was added dropwise to the metal solution in-between 63 min so that the final pH of the solution was 7. After addition of the precipitation agent the mixture was stirred for 180 min at 70° C. The resulting precipitate was filtered and washed with distilled water until the nitrate-test strip indicated that the washing water was free of nitrate ions. The sample was then dried at 110° C. for 15 h under static air, and subsequently calcined at 750° C. for 1 h under static air. The calcined sample was then sieved to obtain the particle fraction needed for testing. The resulting chemical composition of the calcined catalyst, determined by elemental analyses, was 7.4 weight-% Al, 13.1 weight-% Cr and 54 weight-% Zn. The N₂-BET surface area of the calcined powder determined according to Reference Example 1.1 was 21 m²/g. The XRD pattern of the calcined powder determined according to Reference Example 1.4 showed broad reflections which were assigned to zyncite-like phase ZnO and gahnite-like phase Zn(Al_{1.06}Cr_{0.94})O₄. The XRD pattern is shown in FIG. 10.

### Comparative Example 1: Preparation of Comparative Catalysts

The comparative catalysts were prepared by physically mixing (shaking) the mixed metal oxides of Reference Examples 5 and the zeolite material of Reference Examples 2 to 4 in a beaker. The compositions of the catalysts are shown in Table 5 below:

TABLE 5
Composition of the catalysts

| Ref- | | | Vol- | Vol- | Ratio |
|---|---|---|---|---|---|
| erence | Zeolitic | Metal | ume | ume | MO/ |
| Example | material (Zeo) | Oxide (MO) | Zeo/ml | MO/ml | Zeo/g/g |
| RE 6.1 | SAPO-A (RE 2) | Cr₂/ZnO (500° C.) | 1.028 | 0.172 | 0.33 |
| RE 6.2 | SAPO-A (RE 2) | Cr₂/ZnO (500° C.) | 0.681 | 0.519 | 1.5 |
| RE 6.3 | SAPO-B (RE 3) | Cr₂/ZnO (400° C.) | 0.884 | 0.316 | 0.33 |
| RE 6.4 | SAPO-B (RE 3) | Cr₂/ZnO (500° C.) | 1.063 | 0.137 | 0.33 |
| RE 6.5 | SAPO-B (RE-3) | Cr₂/ZnO (750° C.) | 1.067 | 0.133 | 0.33 |
| RE 6.6 | CHA (RE 4) | Cr₂/ZnO (500° C.) | 1.081 | 0.119 | 0.33 |
| RE 6.7 | CHA (RE 4) | Cr/ZnO₂ (500° C.) | 0.800 | 0.400 | 1.5 |
| RE 6.8 | 0.5% | Cr₂/ZnO (500° C.) | 1.028 | 0.172 | 0.33 |
| | Mg-SAPO-A | | | | |
| | (RE 2.1) | | | | |
| RE 6.9 | 1.1% | Cr₂/ZnO (500° C.) | 1.029 | 0.171 | 0.33 |
| | Mg-SAPO-A | | | | |
| | (RE 2.2) | | | | |
| RE 6.10 | 2% | Cr₂/ZnO (500° C.) | 1.026 | 0.174 | 0.33 |
| | Mg-SAPO-A | | | | |
| | (RE 2.3) | | | | |

### Example 1: Preparation of a Molding Comprising a 0.48 Weight-% Mg-CHA Zeolitic Material

a) Providing a Mg-CHA Zeolitic Material

| | |
|---|---|
| CHA zeolitic material of Reference Example 4a) | 80 g |
| Mg(NO₃)₂ × H₂O | 4.1 g |
| De-ionized water | 120 g |

Mg(NO₃)₂×H₂O was dissolved in water and homogenized. The solution was added dropwise to the zeolitic material comprised in a beaker. The impregnated zeolite was transferred in a porcelain bowl. The material was dried at 120° C. and then calcined for 5 hours at 500° C. 82 g of product were obtained. Elemental analysis of the zeolitic material releveled a Mg content of 0.48 weight-%. The NH3-TPD analysis performed as disclosed in Reference Example 1.2 showed the following peaks (see Table 6 below).

TABLE 6
Results of the TPD-NH3 analysis

| Peak | Temperature at | Quantity/ | Peak |
|---|---|---|---|
| number | maximum/° C. | mmol/g | concentration/% |
| 1 | 219 | 0.719 | 1.77 |
| 2 | 475.6 | 0.227 | 0.93 |
| 3 | 573.8 | 0.074 | 0.80 |

The plot of the NH3-TPD analysis is disclosed in FIG. 5.

b) Preparing an Extrudate of the 0.48 Weight-% Mg-CHA Zeolitic Material

Materials Used:

| | |
|---|---|
| 0.48% Mg-CHA zeolitic material, according | 75 g |
| to a) above: | |
| Ludox ® AS40 (Grace; colloidal silica; aqueous | 46.9 g |
| solution, 40 weight-%): | |
| Walocel 5% | 93.8 g |

The zeolitic material, the Ludox® and the Walocel were kneaded for 1 h (with no addition of water). The material obtained was extruded and strands of 1 mm diameter were formed. The strands obtained were dried hours at 120° C. and then calcined for 5 hours at 500° C. 70 g of product were obtained.

### Example 2: Preparation of a Molding of a 1.2 Weight-% Mg-CHA Zeolitic Material

a) Providing a Mg-CHA Zeolitic Material

Materials used

| | |
|---|---|
| CHA zeolitic material of Reference Example 4a) | 80 g |
| Mg(NO₃)₂ × H₂O | 8.8 g |
| De-ionized water | 120 g |

Mg(NO₃)₂×H₂O was dissolved in water and homogenized. The solution was added dropwise to the zeolitic material comprised in a beaker. The impregnated zeolite was transferred in a porcelain bowl. The material was dried at 120° C. and then calcined for 5 hours at 500° C. 82 g of product were obtained. Elemental analysis of the zeolitic material showed a Mg content of 1.2 weight-%. The NH3-TPD analysis performed according to Reference Example 1.2 showed the following peaks (see Table 7 below).

TABLE 7
Results of the TPD-NH3 analysis

| Peak | Temperature at | Quantity/ | Peak |
|---|---|---|---|
| number | maximum/° C. | mmol/g | concentration/% |
| 1 | 220.6 | 0.772 | 1.59 |
| 2 | 487.5 | 0.275 | 0.92 |
| 3 | 591.7 | 0.027 | 0.77 |

The plot of the NH3-TPD analysis is shown in FIG. 6.

b) Preparing an Extrudate of the 1.2 Weight-% Mg-CHA Zeolitic Material

Materials Used:

| | |
|---|---|
| 1.2% Mg-CHA zeolitic material, according to a) above: | 75 g |
| Ludox ® AS40 (Grace; colloidal silica; aqueous | 46.9 g |
| solution, 40 weight-%): | |
| Walocel 5% | 93.8 g |

The zeolitic material, the Ludox® and the Walocel were kneaded for 1 h (with no addition of water). The material obtained was extruded and strands of 1 mm diameter were formed. The strands obtained were dried hours at 120° C. and then calcined for 5 hours at 500° C. 58 g of product were obtained.

### Example 3: Preparation of the Extrudate of a 1.6% Mg-CHA Zeolitic Material

a) Providing a Mg-CHA Zeolitic Material

| | |
|---|---|
| CHA zeolitic material of Reference Example 4a) | 80 g |
| Mg(NO₃)₂ × H₂O | 16.8 g |
| De-ionized water | 120 g |

Mg(NO₃)₂×H₂O was dissolved in water and homogenized. The solution was added dropwise to the zeolitic material comprised in a beaker. The impregnated zeolite was transferred in a porcelain bowl. The material was dried at 120° C. and then calcined for 5 hours at 500° C. 85 g of product were obtained. Elemental analysis of the zeolitic material revealed a Mg content of 1.6 weight-%. The NH3-TPD analysis performed according to Reference Example 1.2 showed the following peaks (see Table 8 below).

TABLE 8
Results of the NH3-TPD analysis

| Peak | Temperature at | Quantity/ | Peak |
|---|---|---|---|
| number | maximum/° C. | mmol/g | concentration/% |
| 1 | 216.5 | 0.978 | 1.40 |
| 2 | 463.3 | 0.127 | 0.79 |
| 3 | 575.9 | 0.086 | 0.788 |

The plot of the NH3-TPD analysis is disclosed in FIG. 7.

b) Preparing an Extrudate of the 1.6% Mg-CHA Zeolitic Material

Materials Used:

| | |
|---|---|
| 1.6% Mg-CHA zeolitic material, according to a) above: | 75 g |
| Ludox ® AS40 (Grace; colloidal silica; aqueous | 46.9 g |
| solution, 40 weight-%): | |
| Walocel 5% | 93.8 g |

The zeolitic material, the Ludox® and the Walocel were kneaded for 1 h (with no addition of water). The material obtained was extruded and strands of 1 mm diameter were formed. The strands obtained were dried hours at 120° C. and then calcined for 5 hours at 500° C. 56 g of product were obtained.

### Example 4: Preparation of Catalysts According to the Invention

The catalysts were prepared by physically mixing (shaking) the mixed metal oxides and the moldings comprising the zeolite material in a beaker. The compositions of the catalysts are shown in Table 9 below.

TABLE 9
Compositions of the catalysts

| | Zeolitic | Metal Oxide | Volume | Volume | Ratio MO/ |
|---|---|---|---|---|---|
| Example | material (Zeo) | (MO) | Zeo/ml | MO/ml | Zeo/g/g |
| E4.1 | 0.5% Mg-CHA | Cr₂/ZnO | 1.024 | 0.176 | 0.33 |
| | (E1) | (500° C.) | | | |
| E4.2 | 1.2% Mg-CHA | Cr₂/ZnO | 1.024 | 0.176 | 0.33 |
| | (E2) | (500° C.) | | | |
| E4.3 | 1.6% Mg-CHA | Cr₂/ZnO | 1.024 | 0.176 | 0.33 |
| | (E3) | (500° C.) | | | |
| E4.4 | 1.6% Mg-CHA | Cr₂/ZnO | 0.784 | 0.416 | 1.5 |
| | (E3) | (500° C.) | | | |

### Example 5: Process for Preparing C2 to C4 Olefins from a Synthesis Gas Stream Comprising H₂ and CO

The catalysts prepared in Examples 4 and in Reference Example 5 (in each case 1.2 ml) were installed in a continuously operated, electrically heated tubular reactor. The catalysts were activated using a gas stream of 10% H₂ in N₂ (10/90 vol %/vol %) at a gas hourly space velocity (GHSV) of 6000 h⁻¹, heating to a temperature of 310° C. (heating rate 1 K/min) for 2 h, cooling to a temperature of 240° C., and washing with a gas stream of H₂/CO (1.5:1). The pressure was slowly brought to 20 bar(abs). The synthesis gas stream to be converted was fed directly into the reactor for conversion into C2 to C4 olefins at a GSHV of 2208 h⁻¹ The pressure was maintained at 20 bar(abs). The reaction parameters were maintained over the entire run time. Downstream of the tubular reactor, the gaseous product mixture was analysed by on-line chromatography. The process varied in the H₂/CO ratio and in the temperature according to following Table 10.

TABLE 10
Process parameters

| | | H₂/CO volume | Temperature | |
|---|---|---|---|---|
| | Time on | ratio of synthesis | during | Pressure/ |
| Stage | stream/h | gas stream | conversion/° C. | bar(abs) |
| 1 | 0-70 | 0.5:1 | 350 | 20 |
| 2 | 71-96 | 1.5:1 | 350 | 20 |
| 3 | 97-120 | 0.5:1 | 400 | 20 |
| 4 | 120-142 | 1.5:1 | 400 | 20 |

The results achieved in the tubular reactor for the catalysts according to Example 4 and Reference Example 5 and with respect to the selectivities are shown in Tables 11 to 14 for each stage. These are the average selectivities during the run time of the catalyst in which the conversion of CO is as indicated in the respective Tables 11 to 14.

TABLE 11
Stage 1

| | | | | | Select. | Select. | | | |
|---|---|---|---|---|---|---|---|---|---|
| | | Conv. | Select. | Select. | C2-C4 | C2-C4 | Select. | Select. | Select. |
| | | CO/ | MeOH/ | CH4 | paraf./ | olefins/ | C5+ | CO₂/ | Others/ |
| Stage 1 | Catalyst | mol-% | mol-% | mol-% | mol-% | mol-% | mol-% | mol-% | mol-% |
| E 5.1 | E 4.1 | 4.901 | 0.000 | 1.784 | 8.530 | 24.563 | 1.364 | 50.763 | 12.996 |
| | E 4.2 | 4.222 | 0.000 | 1.641 | 4.896 | 25.468 | 1.902 | 50.284 | 15.810 |
| | E 4.3 | 3.568 | 0.000 | 2.325 | 3.089 | 29.123 | 1.287 | 50.498 | 13.679 |
| | E 4.4 | 5.542 | 1.680 | 3.459 | 2.255 | 24.094 | 0.724 | 60.567 | 7.222 |
| | RE 6.1 | 3.442 | 2.636 | 4.286 | 8.264 | 10.823 | 0.452 | 71.153 | 2.387 |
| | RE 6.2 | 5.014 | 3.775 | 7.659 | 5.433 | 1.866 | 0.261 | 80.031 | 0.975 |
| | RE 6.3 | 6.240 | 0.000 | 1.308 | 6.723 | 33.422 | 0.689 | 49.888 | 7.971 |
| | RE 6.4 | 5.289 | 0.000 | 1.304 | 6.973 | 31.507 | 0.821 | 49.834 | 9.562 |
| | RE 6.5 | 4.274 | 0.000 | 1.312 | 7.691 | 29.645 | 0.981 | 49.875 | 10.497 |
| | RE 6.6 | 4.924 | 0.000 | 1.909 | 19.845 | 15.109 | 1.122 | 51.967 | 10.048 |
| | RE 6.7 | 10.441 | 0.000 | 1.815 | 7.653 | 27.132 | 1.412 | 49.811 | 12.177 |
| | RE 6.8 | 3.565 | 3.154 | 5.297 | 1.592 | 1.997 | 0.000 | 86.920 | 1.040 |
| | RE 6.9 | 2.634 | 5.592 | 6.932 | 0.277 | 1.904 | 0.000 | 83.969 | 1.326 |
| | RE 6.10 | 2.723 | 6.457 | 7.610 | 0.420 | 3.404 | 0.382 | 79.573 | 2.154 |

TABLE 12
Stage 2

| | | | | | Select. | Select. | | | |
|---|---|---|---|---|---|---|---|---|---|
| | | Conv. | Select. | Select. | C2-C4 | C2-C4 | Select. | Select. | Select. |
| | | CO/ | MeOH/ | CH4 | paraf./ | olefins/ | C5+ | CO₂/ | Others/ |
| Stage 2 | Catalyst | mol-% | mol-% | mol-% | mol-% | mol-% | mol-% | mol-% | mol-% |
| E 5.1 | E 4.1 | 7.332 | 0.000 | 2.784 | 10.157 | 29.372 | 1.177 | 45.862 | 10.648 |
| | E 4.2 | 5.474 | 0.000 | 2.580 | 4.524 | 34.439 | 1.012 | 46.636 | 10.809 |
| | E 4.3 | 4.530 | 0.000 | 4.131 | 3.577 | 31.861 | 0.739 | 51.703 | 7.989 |
| | E 4.4 | 8.142 | 9.820 | 5.213 | 2.556 | 14.658 | 0.595 | 63.420 | 3.738 |
| | RE 6.1 | 5.150 | 10.424 | 7.092 | 7.802 | 2.316 | 0.000 | 71.361 | 1.005 |
| | RE 6.2 | 7.874 | 10.621 | 7.884 | 4.801 | 1.540 | 0.000 | 74.082 | 1.072 |
| | RE 6.3 | 6.924 | 4.477 | 3.160 | 7.463 | 13.404 | 0.591 | 66.597 | 4.308 |
| | RE 6.4 | 6.603 | 2.328 | 2.643 | 8.452 | 23.700 | 0.673 | 55.189 | 7.014 |
| | RE 6.5 | 5.572 | 1.169 | 2.058 | 9.898 | 29.551 | 0.680 | 48.687 | 7.958 |
| | RE 6.6 | 7.656 | 0.000 | 2.602 | 26.550 | 15.133 | 0.994 | 45.746 | 8.975 |
| | RE 6.7 | 15.643 | 0.000 | 2.933 | 16.311 | 20.531 | 1.446 | 46.830 | 11.948 |
| | RE 6.8 | 5.809 | 9.217 | 4.780 | 1.262 | 1.990 | 0.000 | 81.347 | 1.404 |
| | RE 6.9 | 4.824 | 14.728 | 5.985 | 0.502 | 2.271 | 0.000 | 74.862 | 1.653 |
| | RE 6.10 | 4.420 | 15.777 | 7.387 | 0.729 | 3.159 | 0.574 | 70.480 | 1.895 |

TABLE 13
Stage 3

| | | | | | Select. | Select. | | | |
|---|---|---|---|---|---|---|---|---|---|
| | | Conv. | Select. | Select. | C2-C4 | C2-C4 | Select. | Select. | Select |
| | | CO/ | MeOH/ | CH4 | paraf./ | olefins/ | C5+ | CO₂/ | Others/ |
| Stage 3 | Catalyst | mol-% | mol-% | mol-% | mol-% | mol-% | mol-% | mol-% | mol-% |
| E 5.1 | E 4.1 | 7.121 | 0.000 | 3.905 | 8.254 | 29.699 | 0.783 | 48.711 | 8.647 |
| | E 4.2 | 5.586 | 0.000 | 4.168 | 4.710 | 33.169 | 0.878 | 48.268 | 8.807 |
| | E 4.3 | 4.683 | 0.000 | 5.752 | 4.673 | 32.241 | 0.781 | 48.254 | 8.299 |
| | E 4.4 | 6.109 | 0.000 | 7.465 | 5.929 | 29.707 | 0.671 | 49.076 | 7.153 |
| | RE 6.1 | 2.330 | 0.000 | 13.034 | 16.835 | 14.779 | 0.473 | 51.636 | 3.244 |
| | RE 6.2 | 3.209 | 0.000 | 20.352 | 14.178 | 10.276 | 0.577 | 51.019 | 3.598 |
| | RE 6.3 | 9.743 | 0.000 | 2.754 | 6.270 | 36.728 | 0.481 | 48.413 | 5.355 |
| | RE 6.4 | 7.322 | 0.000 | 3.136 | 7.334 | 35.415 | 0.471 | 48.342 | 5.302 |
| | RE 6.5 | 6.626 | 0.000 | 2.703 | 7.770 | 35.219 | 0.478 | 48.282 | 5.549 |
| | RE 6.6 | 7.900 | 0.000 | 3.954 | 25.197 | 14.523 | 0.703 | 48.800 | 6.823 |
| | RE 6.7 | 17.122 | 0.000 | 3.514 | 12.313 | 23.948 | 0.973 | 48.904 | 10.348 |
| | RE 6.8 | 1.780 | 0.000 | 20.484 | 6.931 | 11.335 | 0.614 | 55.705 | 4.931 |
| | RE 6.9 | 1.485 | 0.000 | 23.526 | 3.340 | 9.804 | 0.820 | 56.408 | 6.102 |
| | RE 6.10 | 1.431 | 0.000 | 24.018 | 3.423 | 10.341 | 0.867 | 55.538 | 5.813 |

TABLE 14
Stage 4

| | | | | | Select. | Select. | | | |
|---|---|---|---|---|---|---|---|---|---|
| | | Conv. | Select. | Select. | C2-C4 | C2-C4 | Select. | Select. | Select. |
| | | CO/ | MeOH/ | CH4 | paraf./ | olefins/ | C5+ | CO₂ / | Others/ |
| Stage 4 | Catalyst | mol-% | mol-% | mol-% | mol-% | mol-% | mol-% | mol-% | mol-% |
| E 5.1 | E 4.1 | 14.023 | 0.000 | 5.446 | 17.678 | 20.859 | 1.169 | 45.283 | 9.566 |
| | E 4.2 | 10.383 | 0.000 | 4.980 | 7.964 | 31.255 | 1.093 | 44.901 | 9.808 |
| | E 4.3 | 9.827 | 0.000 | 7.786 | 10.943 | 28.054 | 0.820 | 44.532 | 7.866 |
| | E 4.4 | 9.877 | 0.000 | 9.211 | 10.783 | 26.611 | 0.637 | 46.226 | 6.532 |
| | RE 6.1 | 5.430 | 0.445 | 13.878 | 26.966 | 10.013 | 0.406 | 46.094 | 2.197 |
| | RE 6.2 | 5.923 | 0.708 | 18.740 | 23.458 | 8.003 | 0.337 | 47.001 | 1.754 |
| | RE 6.3 | 15.315 | 0.000 | 3.812 | 10.481 | 33.531 | 0.633 | 45.237 | 6.306 |
| | RE 6.4 | 13.972 | 0.000 | 3.761 | 11.898 | 32.637 | 0.588 | 45.179 | 5.936 |
| | RE 6.5 | 11.936 | 0.000 | 3.926 | 14.625 | 30.069 | 0.617 | 44.771 | 5.991 |
| | RE 6.6 | 14.998 | 0.000 | 4.619 | 43.152 | 3.470 | 1.083 | 44.977 | 2.699 |
| | RE 6.7 | 30.463 | 0.000 | 4.542 | 32.875 | 7.842 | 1.053 | 45.958 | 7.730 |
| | RE 6.8 | 2.761 | 2.495 | 24.213 | 9.401 | 8.701 | 0.470 | 51.862 | 2.858 |
| | RE 6.9 | 2.091 | 1.843 | 28.247 | 4.795 | 7.637 | 0.509 | 53.892 | 3.076 |
| | RE 6.10 | 2.169 | 1.963 | 28.576 | 4.506 | 8.635 | 0.487 | 52.601 | 3.233 |

The selectivities of the catalyst of example E 4.2 with respect to the hydrocarbons are listed in Table 15:

TABLE 15
Average selectivities (S) in % at CO conversions as
indicated of the catalyst of example 4.2

| Product | Stage 1 | Stage 2 | Stage 3 | Stage 4 |
|---|---|---|---|---|
| CO Conversion % | 3.885 | 5.149 | 5.013 | 10.264 |
| S(methane) | 1.930 | 2.922 | 4.675 | 5.069 |
| S(ethane) | 0.503 | 0.981 | 1.645 | 2.281 |
| S(propane) | 2.265 | 2.705 | 2.228 | 4.906 |
| S(butane) | 0.858 | 0.835 | 0.509 | 1.076 |
| S(ethene) | 9.608 | 13.709 | 11.026 | 9.257 |
| S(propene) | 18.443 | 18.776 | 20.748 | 19.441 |
| S(butene) | 2.066 | 1.672 | 1.672 | 1.785 |
| S(Meho) | 0 | 0 | 0 | 0 |
| S(CO2) | 49.511 | 47.252 | 48.229 | 45.034 |

The selectivity's of the catalyst of example E 4.2 with respect to the olefins/paraffin based on the total hydrocarbon (CO₂ subtracted) are listed in Table 16.

TABLE 16
Average selectivities (S)_{ion %} of the catalyst of example 4.2

| Product | Stage 1 | Stage 2 | Stage 3 | Stage 4 |
|---|---|---|---|---|
| S(MeOH) | 0 | 0 | 0 | 0 |
| S(methane) | 1.930 | 2.922 | 4.675 | 5.069 |
| S(C2-C4 paraffins) | 3.626 | 4.520 | 4.381 | 8.26. |
| S(C2-C4 olefins) | 30.116 | 34.157 | 33.445 | 30.483 |
| S(C5+) | 1.458 | 0.957 | 0.832 | 1.146 |

### BRIEF DESCRIPTION OF THE FIGURES

FIG. 1: shows the results NH3-TPD analysis of the zeolitic material 0.5% Mg-SAPO-34 according to Reference Example 2.1

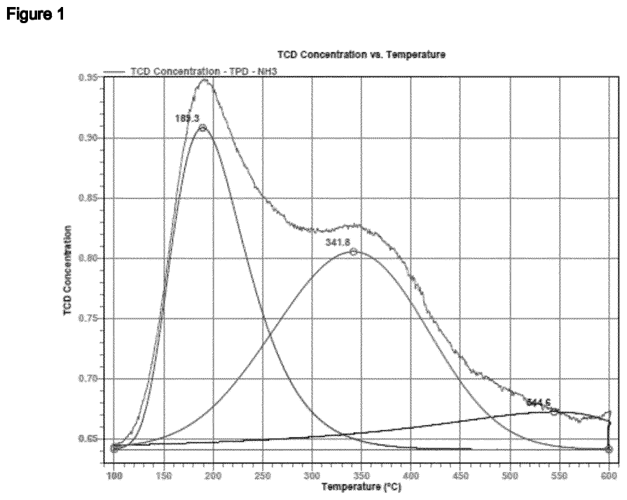

FIG. 2: shows the results NH3-TPD analysis of the zeolitic material 1.1% Mg-SAPO-34 according to Reference Example 2.2

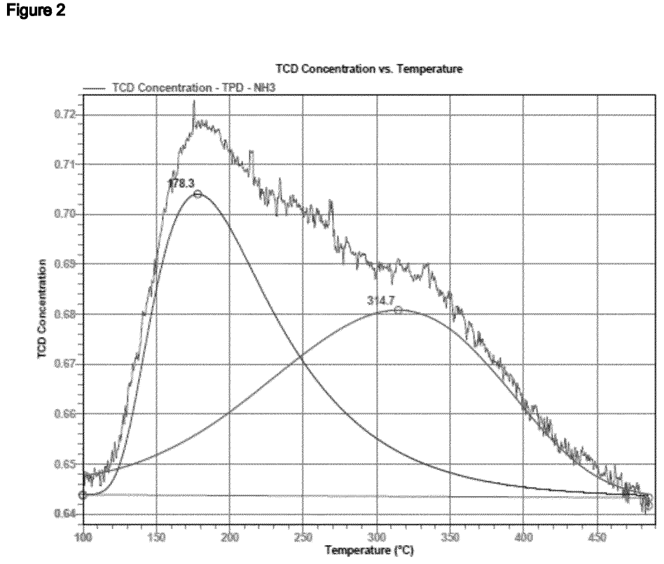

FIG. 3: shows the results NH3-TPD analysis of the zeolitic material 2.0% Mg-SAPO-34 according to Reference Example 2.3

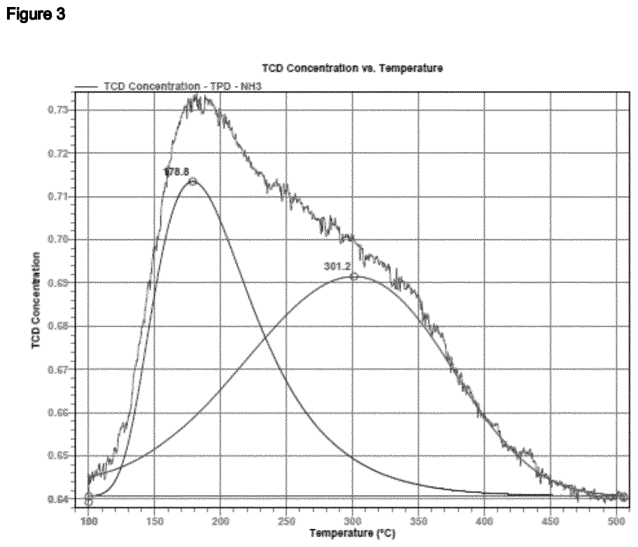

FIG. 4: shows the results NH3-TPD analysis of the zeolitic material SAPO-34 according to Reference Example 3

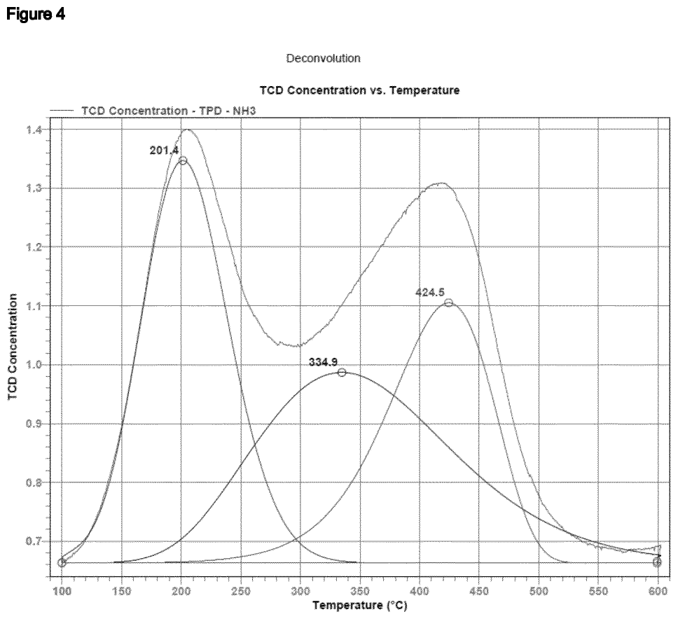

FIG. 5: shows the results NH3-TPD analysis of the zeolitic material 0.48% Mg-CHA according to Example 1

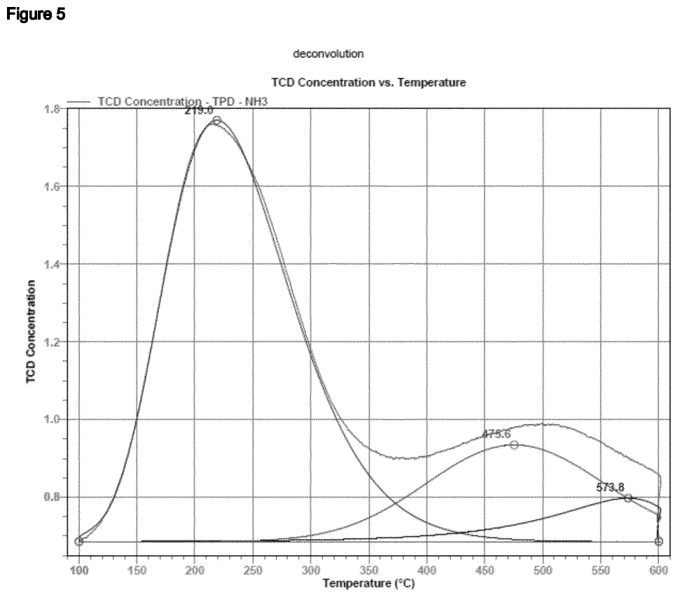

FIG. 6: shows the results NH3-TPD analysis of the zeolitic material 1.2% Mg-CHA according to Example 2

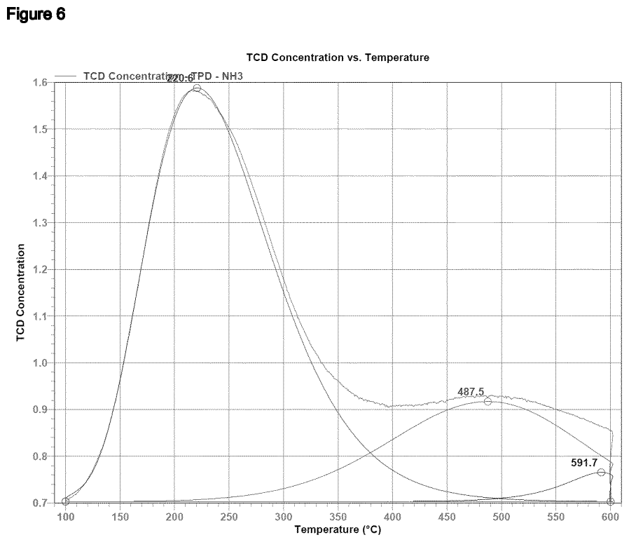

FIG. 7: shows the results NH3-TPD analysis of the zeolitic material 1.6% Mg-CHA according to Example 3

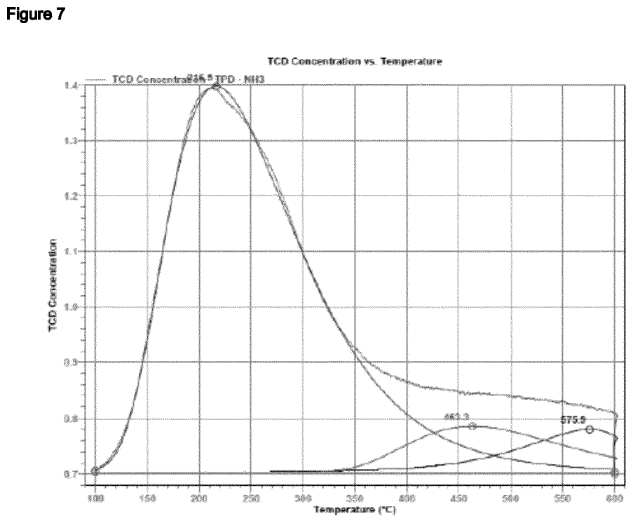

FIG. 8: shows the XRP pattern of the mixed metal oxide of Reference Example 5.1

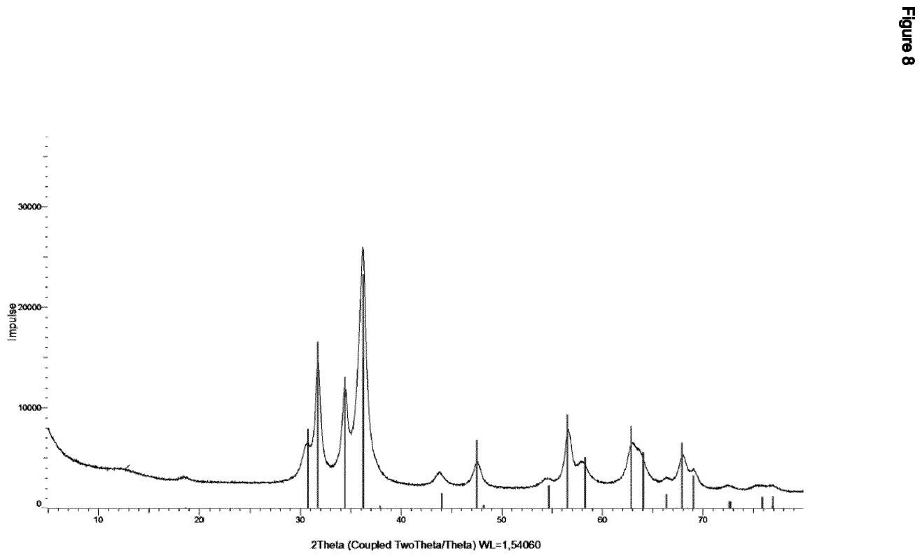

FIG. 9: shows the XRP pattern of the mixed metal oxide of Reference Example 5.2

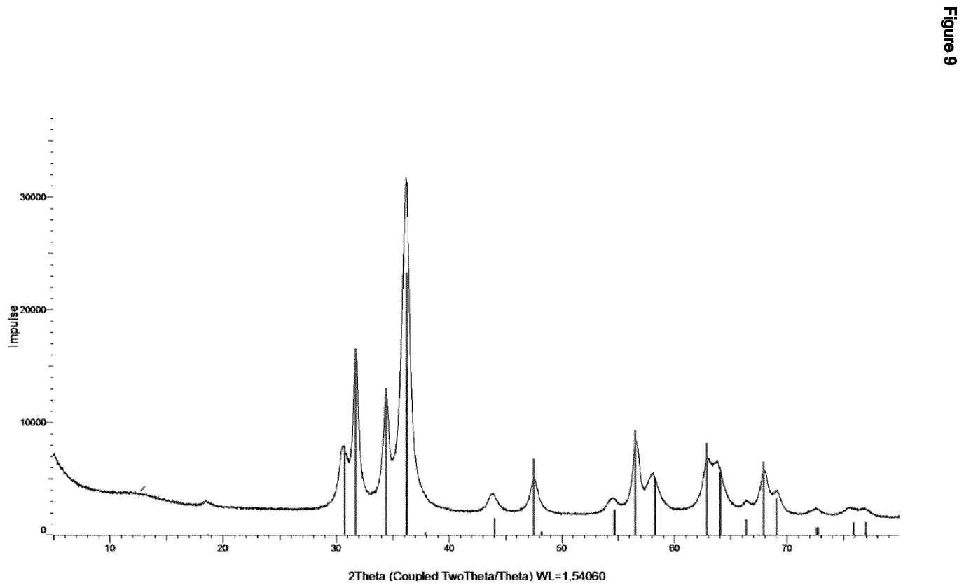

FIG. 10: shows the XRP pattern of the mixed metal oxide of Reference Example 5.3

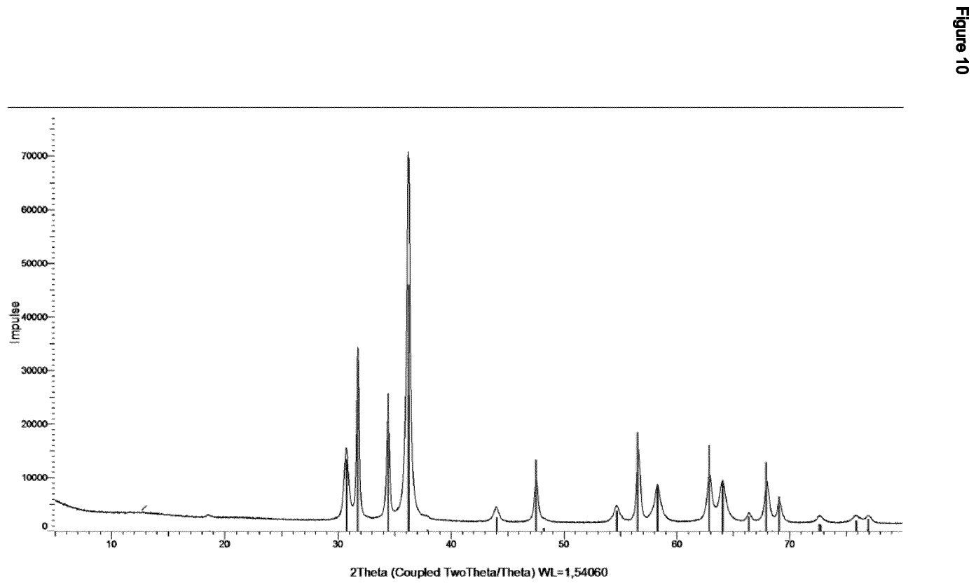

### CITED PRIOR ART

U.S. Pat. No. 4,049,573
Goryainova et al., in: Petroleum Chemistry, vol. 51, no. 3 (2011) pp. 169-173
Wan, V. Y., Methanol to Olefins/Propylene Technologies in China, Process Economics Program, 261A (2013)
Li, J., X. Pan and X. Bao, Direct conversion of syngas into hydrocarbons over a core-shell Cr—Zn@SiO2@SAPO-34 catalyst, Chinese Journal of Catalysis vol. 36 no. 7 (2015), pp. 1131-1135

1.-15. (canceled)

16. A composition comprising
a) a molding comprising a zeolitic material having framework type CHA, wherein the zeolitic material has a framework structure comprising a tetravalent element Y, a trivalent element X, and oxygen, wherein the zeolitic material further comprises one or more alkaline earth metals M; and
b) a mixed metal oxide comprising chromium, zinc, and aluminum;
wherein Y is one or more of Si, Ge, Sn, Ti, and Zr;
wherein X is one or more of Al, B, Ga, and In.

17. The composition of claim 16, wherein Y is Si and X is Al.

18. The composition of claim 16, wherein in the framework structure of the zeolitic material, the molar ratio Y:X calculated as YO₂:X₂O₃ is at least 5:1.

19. The composition of claim 16, wherein at least 95 weight-% of the framework structure of the zeolitic material consist of Y, X, O, and H.

20. The composition of claim 16, wherein the one or more alkaline earth metals M is one or more of Be, Mg, Ca, Sr and Ba.

21. The composition of claim 16, wherein the zeolitic material comprises the one or more alkaline earth metals M, calculated as elemental alkaline earth metal, in a total amount in the range of from 0.1 to 5 weight-%, based on the weight of the zeolitic material comprised in the molding.

22. The composition of claim 16, wherein the zeolitic material has an amount of medium acid sites, wherein the amount of medium acid sites is the amount of desorbed ammonia per mass of the calcined zeolitic material as measured according to the temperature programmed desorption of ammonia in the temperature range of from 100 to 350° C. determined according to the method as described in Reference Example 1.2, wherein the amount of medium acid sites is at least 0.7 mmol/g and wherein the zeolitic material has an amount of strong acid sites, wherein the amount of strong acid sites is the amount of desorbed ammonia per mass of the calcined zeolitic material as measured according to the temperature programmed desorption of ammonia in the temperature range of from 351 to 500° C. determined according to the method as described in Reference Example 12, wherein the amount of strong acid sites is less than 1.0 mmol/g.

23. The composition of claim 16, wherein the molding further comprises a binder material.

24. The composition of claim 23, wherein in the molding, the weight ratio of the zeolitic material relative to the binder material is in the range of from 1:1 to 20:1.

25. The composition of claim 16, wherein at least 98 weight-% of the mixed metal oxide consists of chromium, zinc, aluminum, and oxygen.

26. The composition of claim 25, wherein in the mixed metal oxide, the weight ratio of the zinc, calculated as element, relative to the chromium, calculated as element, is in the range of from 2.5:1 to 6.0:1, the weight ratio of the aluminum, calculated as element, relative to the chromium, calculated as element, is in the range of from 0.1:1 to 2:1 and the weight ratio of the mixed metal oxide relative to the zeolitic material is at least 0.2:1.

27. The composition of claim 16, wherein at least 95 weight-% of the composition consist of the molding and the mixed metal oxide.

28. A process for preparing the composition according to claim 16, the process comprising
(i) providing a molding comprising a zeolitic material having framework type CHA, wherein the zeolitic material has a framework structure comprising a tetravalent element Y, a trivalent element X, and oxygen, wherein the zeolitic material further comprises one or more alkaline earth metals M, wherein Y is one or more of Si, Ge, Sn, Ti, and Zr, wherein X is one or more of Al, B, Ga, and In;
(ii) providing a mixed metal oxide comprising chromium, zinc, and aluminum;
(iii) mixing the molding provided according to (i) with the mixed metal oxide provided according to (ii), obtaining the composition.

29. A process for preparing C2 to C4 olefins from a synthesis gas comprising hydrogen and carbon monoxide, the process comprising
(1) providing a gas stream which comprises a synthesis gas stream comprising hydrogen and carbon monoxide;
(2) providing a catalyst comprising the composition according to claim 16;
(3) bringing the gas stream provided in (1) in contact with the catalyst provided in (2), obtaining a reaction mixture stream comprising C2 to C4 olefins.

30. The process of claim 29, wherein the reaction mixture obtained according to (3) comprises ethene, propene, and butene, wherein in the reaction mixture obtained according to (3), the molar ratio of propene relative to ethene is greater than 1 and the molar ratio of ethene relative to butene is greater than 1.
